(19) United States
(12) Patent Application Publication
(10) Pub. No.: US 2025/0062719 A1
(43) Pub. Date: Feb. 20, 2025

(54) SYSTEM AND METHOD FOR DETERMINATION OF SOILING LOSS ON SOLAR PANELS OF PHOTOVOLTAIC (PV) POWER PLANT

(71) Applicant: ACWA POWER Company, Riyadh (SA)

(72) Inventors: Ahmed Hesham BALAWI, Thuwal (SA); Thomas ALTMANN, Dubai (AE)

(73) Assignee: ACWA POWER Company, Riyadh (SA)

(21) Appl. No.: 18/804,675

(22) Filed: Aug. 14, 2024

Related U.S. Application Data
(60) Provisional application No. 63/519,784, filed on Aug. 15, 2023.

(51) Int. Cl. H02S 50/10; H02S 40/10

(52) U.S. Cl. CPC H02S 50/10; H02S 40/10

(57) ABSTRACT

A system and method determines soiling loss on solar panels of photovoltaic (PV) power plant by obtaining a first set of information that includes location of a set of the solar panels and configuration of the solar panels of that set. The system and method also obtains a second set of information that includes real-time operating parameters associated with the PV power plant based upon the first set of information. The first and second sets of information are fed to a machine-learning (ML) model to determine a soiling loss associated with the set of solar panels based upon an output of the ML model and, when appropriate, the system and method issues an alert based upon the determined soiling loss.

### CROSS-REFERENCE TO RELATED APPLICATION

This application claims priority to U.S. Provisional Patent Application Ser. No. 63/519,784, filed Aug. 15, 2023 and entitled SYSTEM AND METHOD FOR PHOTOVOLTAIC (PV) PLANT MONITORING AND DIAGNOSTICS, the disclosure of which is incorporated herein by reference.

### TECHNOLOGICAL FIELD

The present disclosure generally relates to a photovoltaic (PV) plant, and more particularly relates to a system and a method for determination of soiling loss on solar panels of a photovoltaic (PV) power plant.

### BACKGROUND

With the advantages in the field of electrical engineering, photovoltaic (PV) industry has been rapidly growing as solar energy becomes a trending source of renewable energy. The PV industry utilizes PV power plants as power generation facilities to generate electric power by utilizing solar energy. The solar energy is a clean, renewable source that utilizes solar radiation to produce electric power. The generation of electric power in PV plants is based on photoelectric effect, by which certain materials can absorb photons (such as light particles) and release electrons, generating an electric current. This photoelectric effect is utilized by semiconductor devices like PV cells to generate electricity. For example, PV cells can be made of monocrystalline, polycrystalline or amorphous silicon, or other thin-film semiconductor materials.

PV power plants further include various components such as PV panels, solar trackers, inverters, transformers, and so forth. Each PV panel corresponds to a group of PV cells configured to capture solar radiation and transform light into electrical energy. Typically, soiling, or the accumulation of dirt and debris on PV panels, is a significant problem for the solar industry, particularly in arid and dusty regions where dust and sandstorms can lead to large amounts of soiling. The accumulated dust and debris on PV panels can cause a daily decrease in power generation, significantly impacting the overall performance of solar power plants. The impact of soiling on power generation is dependent on a range of factors, including the location of the solar power plant, prevailing weather conditions, the design and installation of PV panels, and maintenance practices. Even in areas with relatively low dust levels, soiling can still be an issue, especially if there is little rainfall to naturally clean the PV modules. To mitigate the effects of soiling, the PV industry spends significant costs and employs various techniques including anti-soiling coatings, water cleaning, and electrodynamic dust removal. Therefore, determination of the soiling loss may be a critical factor in optimizing the efficiency and financial performance of solar facilities of the PV power plant.

However, determination of the soiling loss of the PV power plant is challenging due to the dependence of soiling on various factors such as the location of the PV panels, a composition and type of soiling, and a length of time that the soiling has been accumulated. In addition, the soiling rate may vary depending on various times of year, the weather conditions, and surrounding environment that may make it difficult to accurately determine the soiling loss. Despite such challenges, determination of the soiling loss is crucial for accurately assessing the performance and economic viability of the PV panels.

Several methods have been used to quantify soiling rates in the PV panels. A commonly used approach is to measure the difference in energy output between a soiled and clean panel. However, such a method has several limitations, including a need for the clean (reference) panel, difficulty in finding an identical clean panel, and inability to distinguish between soiling and other factors affecting the panel performance. Another method utilizes satellite-based remote sensing, that may measure a difference in reflectivity between clean and dirty surfaces of the panels. However, such methods may be economically expensive and may not capture localized soiling patterns on the panel or a PV string scale. Yet another method to quantify soiling is to use a deposition gauge that may measure the amount of soiling on the panel. However, such a method has some drawbacks such as being sensitive to moisture and temperature causing variations in readings, being a point measurement tool that only measures soiling at one spot on the module, a frequent need of calibration to ensure accurate readings that may in turn time consuming and expensive. Thus, the conventional methods of determination of soiling loss may be inefficient.

Therefore, there is a need of an improved method for determination of soiling loss to solve the problems associated with the traditional methods.

### BRIEF SUMMARY

A system, a method, and a computer programmable product are provided for implementing the process of determination of soiling loss on solar panels of photovoltaic (PV) power plant.

In one aspect, a system for determination of soiling loss on solar panels of photovoltaic (PV) power plant is disclosed. The system includes a memory configured to store a computer-executable instruction, and one or more processors are operatively coupled to the memory. The one or more processors may be configured to obtain first information including location information associated with a set of solar panels of a photovoltaic (PV) power plant and configuration information associated with the set of solar panels of the PV power plant. The one or more processors may further be configured to obtain second information including real-time operating parameters associated with the PV power plant from a set of sensors based on the obtained first information. Each sensor of the set of sensors may be associated with the set of solar panels. The one or more processors may further be configured to provide, as an input, the obtained first information and the obtained second information to a machine learning (ML) model. The ML model may be a pre-trained model. The one or more processors may further be configured to determine a soiling loss associated with the set of solar panels based on an output of the ML model. The one or more processors may further be configured to render an alert based on the determined soiling loss.

In additional system embodiments, the one or more processors may further be configured to compare the determined soling loss with a pre-determined threshold loss. The one or more processors may further be configured to render the alert based on the comparison.

In additional system embodiments, the real-time operating parameters may further include an operational current parameter associated with the set of solar panels, an operational voltage parameter associated with the set of solar panels, a tilt angle of one or more trackers associated with the set of solar panels, and an internal temperature of an inverter associated with the PV power plant.

In additional system embodiments, the first information may further include real time weather information associated with a location of installation of the set of solar panels. The location information associated with the set of solar panels may include the location associated with the set of solar panels.

In additional system embodiments, the real-time weather information associated with the location of the set of solar panels may further include at least one of solar irradiance at the location of the set of solar panels, a wind speed at the location of the set of solar panels, a wind direction at the location of the set of solar panels, an ambient temperature at the location of the set of solar panels, solar irradiance at a front plane of the set of solar panels, solar irradiance at a rear plane of the set of solar panels, a temperature of the set of solar panels, or a humidity at the location of the set of solar panels.

In additional system embodiments, the one or more processors may further be configured to validate the obtained second information associated with the set of solar panels based on application of one or more data validation techniques on the obtained second information. The one or more processors are further configured to provide, as the input, the validated second information and the real-time weather information to the ML model.

In additional system embodiments, the one or more processors may further be configured to obtain reference information associated with the set of solar panels from one or more sources based on the obtained second information. The reference information may include at least one of a commissioning date associated with the set of solar panels and the pre-determined threshold loss. The one or more processors may further be configured to provide, as the input, the obtained reference information, to the ML model and determine the soiling loss associated with the set of solar panels based on the output of the ML model.

In additional system embodiments, the output of the ML model may be a diagnostic chart indicative of one of an increase in the soiling loss over a first time period, a decrease in the soiling loss over the first time period, or no change in the soiling loss over the first time period.

In additional system embodiments, the obtained second information associated with the solar panels may be constrained with respect to the first time period.

In another aspect, a method for determination of soiling loss on solar panels of photovoltaic (PV) power plant is disclosed. The method may include obtaining first information including location information associated with a set of solar panels of a photovoltaic (PV) power plant and configuration information associated with the set of solar panels of the PV power plant. The method may further include obtaining second information including real-time operating parameters associated with the PV power plant from a set of sensors based on the obtained first information. Each sensor of the set of sensors may be associated with the set of solar panels. The method may further include providing, as an input, the obtained first information and the obtained second information, to a machine learning (ML) model. The ML model may be a pre-trained model. The method may further include determining a soiling loss associated with the set of solar panels based on an output of the ML model. The method may further include rendering an alert based on the determined soiling loss.

In additional method embodiments, the method may further include comparing the determined soling loss with a pre-determined threshold loss. The method may further include rendering an alert based on the comparison.

In additional method embodiments, the real-time operating parameters may further include an operational current parameter associated with the set of solar panels, an operational voltage parameter associated with the set of solar panels, a tilt angle of one or more trackers associated with the set of solar panels, and an internal temperature of an inverter associated with the PV power plant.

In additional method embodiments, the first information may further include real time weather information associated with a location of installation of the set of solar panels. The location information associated with the set of solar panels may include the location associated with the set of solar panels.

In additional method embodiments, the real-time weather information associated with the location of the set of solar panels may further include at least one of solar irradiance at the location of the set of solar panels, a wind speed at the location of the set of solar panels, a wind direction at the location of the set of solar panels, an ambient temperature at the location of the set of solar panels, solar irradiance at a front plane of the set of solar panels, solar irradiance at a rear plane of the set of solar panels, a temperature of the set of solar panels, or a humidity at the location of the set of solar panels.

In additional method embodiments, the method may further include validating the obtained second information associated with the set of solar panels based on application of one or more data validation techniques on the obtained second information. The method may further include providing, as the input, the validated second information and the real-time weather information to the ML model.

In additional method embodiments, the method may further include obtaining reference information associated with the set of solar panels from one or more sources based on the obtained second information. The reference information may include at least one of a commissioning date associated with the set of solar panels and the pre-determined threshold loss. The method may further include providing the obtained reference information, as the input, to the ML model. The method may further include determining the soiling loss associated with the set of solar panels based on the output of the ML model.

In additional method embodiments, the output of the ML model may be a diagnostic chart indicative of one of an increase in the soiling loss over a first time period, a decrease in the soiling loss over the first time period, or no change in the soiling loss over the first time period. The obtained second information associated with the set of solar panels may be constrained with respect to the first time period.

In additional method embodiments, the diagnostic chart may correspond to a heatmap associated with the PV power plant. The heatmap may indicate a distribution of the soiling loss over the PV power plant.

In additional method embodiments, the method may further include generating one or more charts indicative of the soiling loss based on the obtained first information, obtained second information, the determined soiling loss, and a training dataset associated with historical soiling loss events. The ML model may be pre-trained on the training dataset. The method may further include rendering the generated one or more charts.

In yet another aspect, a computer program product including a non-transitory computer readable medium having stored thereon computer executable instruction which when executed by at least one processor, cause the processor to conduct operations for determination of soiling loss on solar panels of photovoltaic (PV) power plant is disclosed. The operations may include obtaining first information including location information associated with a set of solar panels of a photovoltaic (PV) power plant and configuration information associated with the set of solar panels of the PV power plant. The operations may further include obtaining second information including real-time operating parameters associated with the PV power plant from a set of sensors based on the obtained first information. Each sensor of the set of sensors may be associated with the set of solar panels. The operations may further include providing, as an input, the obtained first information and the obtained second information, to a machine learning (ML) model. The ML model may be a pre-trained model. The operations may further include determining a soiling loss associated with the set of solar panels based on an output of the ML model. The operations may further include transmitting one or more instructions associated with cleaning of at least one solar panel of the set of solar panels to at least one of a set of robots or a set of user devices based on the determined soiling loss. The set of user devices may be associated with a set of operators associated with the PV power plant.

The disclosed system may tend to solve the problems associated with additional hardware requirements in the traditional systems. Additionally, the non-requirement of any additional hardware helps in eliminating installation costs, which helps in making the disclosure a cost-effective solution. This also helps in eliminating the maintenance costs associated with the additional hardware which further contributes to improving the economic feasibility of the solution.

The disclosed system may solve the problems related with point measurement by reflecting the direct effects of soiling on the performance of the PV string, providing a more accurate measurement of the impact of soiling on the PV power plant. Further, the disclosed system may map the distribution of soiling loss along the whole area of the PV power plant which allows a better understanding of the extent of soiling and enables the identification of areas that require more frequent cleaning, further optimizing the cleaning schedule of the PV power plant.

In conclusion, the disclosed system may offer an efficient, cost-effective, and accurate solution for soiling loss determination and may significantly contribute to the optimization of performance and maintenance of the PV power plant. The disclosed system may be directly applicable to monitor and diagnose soiling to determine soiling loss in large scale PV power plants. By providing real-time information on soiling rates, the disclosed system may help the operators optimize the cleaning schedule and reduce energy losses due to soiling.

The disclosed system may be applied to small-scale residential solar systems to provide homeowners with information on soiling rates and trends, helping them to optimize cleaning schedules and optimize performance. The disclosed system may further be applied to Building-Integrated photovoltaic (BIPV) systems integrated into building facades and roofs. The BIPV are photovoltaic materials that are used to replace conventional building materials in parts of building envelope such as the roof, skylights, or facades. By real-time monitoring and diagnosis of soiling loss, the disclosed system may help maintain the aesthetics appearance of the building while optimizing performance. The disclosed system may further be applied to PV panels integrated with Electric Vehicle (EV) charging stations. By determining the soiling loss, the disclosed system may help optimize the cleaning schedules and improve the reliability of the charging stations. Overall, the disclosed system may be applied to any application that utilizes PV panels and can benefit from real time monitoring and diagnosis of soiling loss.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

Having thus described example embodiments of the disclosure in general terms, reference will now be made to the accompanying drawings, which are not necessarily drawn to scale, and wherein:

FIG. 1 illustrates a network environment for determination of soiling loss on solar panels of a photovoltaic (PV) power plant, in accordance with an embodiment of the present disclosure;

FIG. 2 illustrates a block diagram of the system of FIG. 1, in accordance with an embodiment of the present disclosure;

FIG. 3 is a diagram that illustrates exemplary operations for determination of soiling loss on solar panels of a photovoltaic (PV) power plant, in accordance with an embodiment of the disclosure;

FIG. 4 illustrates a block diagram depicting training of an exemplary machine learning model for determination of soiling loss on solar panels, in accordance with an exemplary embodiment of the disclosure;

FIG. 5 is a diagram that illustrates an exemplary alert associated with the soiling loss, in accordance with an embodiment of the disclosure;

FIG. 6A illustrates an exemplary first diagnostic chart, as an output, of the machine learning model, in accordance with an embodiment of the disclosure;

FIG. 6B illustrates an exemplary second diagnostic chart, as an output, of the machine learning model, in accordance with an embodiment of the disclosure;

FIG. 6C illustrates an exemplary third diagnostic chart, as an output, of the machine learning model, in accordance with an embodiment of the disclosure;

FIG. 7 is a diagram that illustrates an exemplary heatmap depicting soiling loss on solar panels of the photovoltaic power plant, in accordance with an embodiment of the disclosure;

FIG. 8 is a flowchart that illustrates a first exemplary method for determination of soiling loss on solar panels of a photovoltaic (PV) power plant, in accordance with an embodiment of the disclosure;

FIG. 9 is a flowchart that illustrates a second exemplary method for determination of soiling loss on solar panels of a photovoltaic (PV) power plant, in accordance with an embodiment of the disclosure.

### DETAILED DESCRIPTION

In the following description, for purposes of explanation, numerous specific details are set forth in order to provide a thorough understanding of the present disclosure. It will be apparent, however, to one skilled in the art that the present disclosure may be practiced without these specific details. In other instances, systems and methods are shown in block diagram form only in order to avoid obscuring the present disclosure.

Some embodiments of the present disclosure will now be described more fully hereinafter with reference to the accompanying drawings, in which some, but not all, embodiments of the disclosure are shown. Indeed, various embodiments of the disclosure may be embodied in many different forms and should not be construed as limited to the embodiments set forth herein; rather, these embodiments are provided so that this disclosure will satisfy applicable legal requirements. Like reference numerals refer to like elements throughout. Also, reference in this specification to “one embodiment” or “an embodiment” means that a particular feature, structure, or characteristic described in connection with the embodiment is included in at least one embodiment of the present disclosure. The appearance of the phrase “in one embodiment” in various places in the specification are not necessarily all referring to the same embodiment, nor are separate or alternative embodiments mutually exclusive of other embodiments. Further, the terms “a” and “an” herein do not denote a limitation of quantity, but rather denote the presence of at least one of the referenced items. Moreover, various features are described which may be exhibited by some embodiments and not by others. Similarly, various requirements are described which may be requirements for some embodiments but not for other embodiments. As used herein, the terms “data”, “content,” “information”, and similar terms may be used interchangeably to refer to data capable of being displayed, transmitted, received, and/or stored in accordance with embodiments of the present disclosure. Thus, the use of any such terms should not be taken to limit the spirit and scope of embodiments of the present disclosure.

As defined herein, a “computer-readable storage medium,” which refers to a non-transitory physical storage medium (for example, a volatile or non-volatile memory device), may be differentiated from a “computer-readable transmission medium,” which refers to an electromagnetic signal.

The embodiments are described herein for illustrative purposes and are subject to many variations. It is understood that various omissions and substitutions of equivalents are contemplated as circumstances may suggest or render expedient but are intended to cover the application or implementation without departing from the spirit or the scope of the present disclosure. Further, it is to be understood that the phraseology and terminology employed herein are for the purpose of the description and should not be regarded as limiting. Any heading utilized within this description is for convenience only and has no legal or limiting effect.

The present disclosure may provide a system, a method, and a computer programmable product for determination of soiling loss on solar panels of a photovoltaic (PV) power plant. The disclosed system presents an efficient, cost-effective, and accurate approach for determining soiling loss and significantly contributes to optimizing performance and maintenance of the PV power plants. One or more operators (or workers) associated with the PV power plant may utilize determined soiling loss to optimize cleaning schedules, thereby reducing energy losses due to soiling. Furthermore, the disclosed system may help in the management of the substantial expenses associated with soiling loss in PV power plants. Additionally, applicability of the disclosed system may extend to PV panels integrated with Electric Vehicle (EV) charging stations, enhancing their reliability through optimized cleaning schedules.

Furthermore, the disclosed system may even find relevance in Building-Integrated Photovoltaic (BIPV) systems integrated into building facades and roofs. The proposed solution not only maintains the aesthetic appearance of buildings but also optimizes performance. Similarly, for small-scale residential solar systems, the system may provide homeowners with insights into soiling rates and trends. This information assists in optimizing cleaning schedules and overall system performance. In essence, the system's real-time monitoring and diagnosis capabilities benefit any application utilizing PV panels.

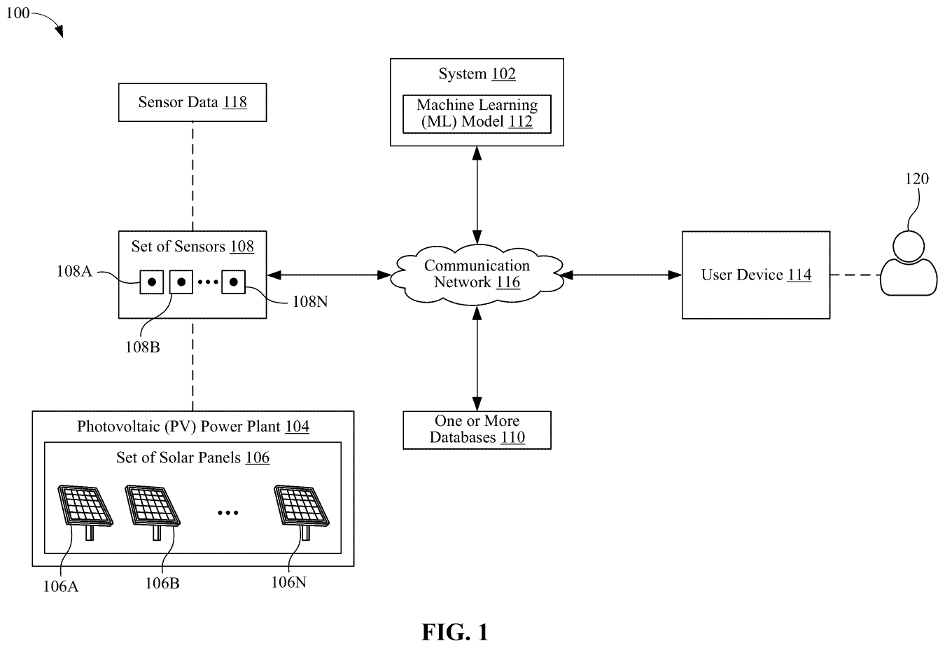

FIG. 1 is a diagram that illustrates a network environment 100 of a system 102 for determination of soiling loss on solar panels of a photovoltaic (PV) power plant, in accordance with an embodiment of the present disclosure. With reference to FIG. 1, there is shown a diagram of the network environment 100. The network environment 100 includes a system 102, a photovoltaic (PV) power plant 104, a set of solar panels 106, a set of sensors 108, and one or more databases 110. The network environment 100 further includes a machine learning model 112, a user device 114, a communication network 116, sensor data 118 and a user 120. The set of solar panels 106 may include a first solar panel 106A, a second solar panel 106B, up to an Nth solar panel 106N. The set of sensors 108 may include one or more sensors, for example, a first sensor 108A, a second sensor 108B, up to an Nth sensor 108N.

The system 102 may include suitable logic, circuitry, interfaces, and/or code that may be configured to determine soiling loss associated with the set of solar panels 106 of the photovoltaic (PV) power plant 104. In this context, the system 102 may be configured to obtain first information including location information associated with the set of solar panels 106 of the PV power plant 104 and configuration information associated with the set of solar panels 106 of the PV power plant 104. The system 102 may be configured to obtain second information including real-time operating parameters associated with the PV power plant 104 from the set of sensors 108 based on the obtained first information. The set of sensors 108 may be associated with the set of solar panels 106. The system 102 may be configured to provide the obtained first information and the obtained second information as an input to the ML model 112. The ML model 112 is a pre-trained model. The system 102 may further be configured to determine a soiling loss associated with the set of solar panels 106 based on an output of the ML model 112. Further, the system 102 may be configured to render an alert based on the determined soiling loss. Examples of the system 102 may include, but are not limited to, a computing device, a mainframe machine, a server, a computer workstation, a smartphone, a cellular phone, a mobile phone, a gaming device, and/or a consumer electronic (CE) device.

The Photovoltaic (PV) power plant 104 may correspond to a large-scale grid-connected photovoltaic power system designed to supply power to the electrical grid. The PV power plant 104 may be configured to generate electricity from sunlight using photoelectric effect phenomenon. Photoelectric effect may be a scientific phenomenon in which specific materials absorb sunlight photons to displace electrons and generate a direct current (DC). An inverter associated with the PV power plant 104 may then convert the DC current into alternating current (AC). The PV power plant 104 may be crucial for the clean energy transition, as the process utilizes sunlight as a source to generate energy, thereby not generate polluting gases and is a cost-effective option for new electricity generation. Examples of the photovoltaic (PV) power plant 104 may include at least one of, but not limited to, a solar park, a solar farm, and a solar power plant.

The PV power plant 104 may further include the set of solar panels 106. The set of solar panels 106 may further include the first solar panel 106A, the second solar panel 106B, up to the Nth solar panel 106N. Each solar panel of the set of solar panels 106 may be composed of photovoltaic cells capable of efficiently capturing sunlight and converting it into electricity. The set of solar panels 106 may be arranged in large arrays across vast areas and may be directly connected to inverters that convert the DC electricity into alternating current (AC), which may be suitable for distribution through power lines. The generated electricity may then be fed into the grid associated with the PV power plant 104, contributing to the overall energy supply. Examples of each solar panel of the set of solar panels 106 may include at least, but not limited to, a monocrystalline solar panel, a polycrystalline solar panel, a thin film solar panel, and a Passivated Emitter and Rear Cell (PERC) solar panel.

Each sensor of the set of sensors 108 may include suitable logic, circuitry, interfaces, and/or code that may be configured to detect and measure physical phenomena, converting them into digital or analog signals that can be processed by the system 102. The set of sensors 108 may include the first sensor 108A, the second sensor 108B, up to the Nth sensor 108N. Each sensor of the set of sensors 108 may be configured to generate the sensor data 118 associated with the set of solar panels 106. In an embodiment, the sensor data 118 may include real-time operating parameters associated with the PV power plant 104. In an exemplary embodiment, the set of sensors 108 may include, for example, but not limited to a set of current measuring sensors and a set of voltage measuring sensors. The set of current measuring sensors may be configured to generatean operational current parameter associated with the set of solar panels 106 and the set of voltage measuring sensors may be configured to generate an operational voltage parameter associated with the set of solar panels 106.

In another exemplary embodiment, the set of sensors 108 may include, for example, but not limited to, a set of temperature measuring sensors. The set of temperature measuring sensors may be configured to measure an internal temperature of the inverter associated with the set of solar panels 106 of the PV power plant 104. In yet another exemplary embodiment, the set of sensors 108 may include, for example, a set of motion sensors. The set of motion sensors may be configured to generate a tilt angle of one or more trackers associated with the set of solar panels 106 of the PV power plant 104. The one or more trackers may refer to one or more devices associated with the set of solar panels 106 that allow each solar panel of the set of solar panels 106 to follow the sun's path in the sky for maximizing energy production of the PV power plant. The set of sensors 108 may further include a set of precipitation measuring sensors for measuring rainfall (precipitation) at the location of installation of the set of solar panels 106. Examples of the set of sensors 108 may further include, but not limited to, a set of inertia sensors, a set of image capture sensors, a set of proximity sensors, a set of Light Detection and Ranging (LiDAR) sensors, and a set of ultrasonic sensors.

Each of the one or more databases 110 may include suitable logic, circuitry, interfaces, and/or code that may be configured to organize the collection of data stored in a computer (say the system 102), typically in the form of tables with rows and columns. The one or more databases 110 may include various databases such as, but not limited to, a first database, and a second database. Further, the one or more databases 110 may include a first table, and a second table. The one or more databases 110 may be managed by a database management system (DBMS) that may facilitate data entry, storage, retrieval, and organization The one or more databases 110 may allow easy access, management, modification, and organization of data. In an embodiment, each of the one or more databases 110 may correspond to one of a relational (SQL) database or a non-relational (NoSQL) database, offering different query languages and data organization methods. The one or more databases 110 may support transactional and analytical data processing, enabling real-time recording of activities and informed decision-making through data analysis.

The one or more databases 110 may be connected to the system 102 and the PV power plant 104 via the communication network 116. In this context, the one or more databases 110 may be configured to store data and information generated by the system 102 and/or the set of sensors 108. In an embodiment, the one or more databases 110 may store the sensor data 118 generated by the set of sensors 108. In an embodiment, the system 102 may be configured to retrieve the sensor data 118 associated with the set of solar panels 106 from the one or more databases 110.

The machine learning model 112 may correspond to a neural network-based classifier. The neural network may be a computational network or a system of artificial neurons, arranged in a plurality of layers, as nodes. The plurality of layers of the neural network may include an input layer, one or more hidden layers, and an output layer. Each layer of the plurality of layers may include one or more nodes (or artificial neurons). Outputs of all nodes in the input layer may be coupled to at least one node of the hidden layer(s). Similarly, inputs of each hidden layer may be coupled to outputs of at least one node in other layers of the neural network. Outputs of each hidden layer may be coupled to inputs of at least one node in other layers of the neural network. Node(s) in the final layer may receive inputs from at least one hidden layer to output a result.

The number of layers and the number of nodes in each layer may be determined from hyper-parameters of the neural network. Such hyper-parameters may be set before or while training the neural network on a training dataset. Each node of the neural network may correspond to a mathematical function (e.g., a sigmoid function or a rectified linear unit) with a set of parameters, tunable during training of the neural network. The set of parameters may include, for example, a weight parameter, a regularization parameter, and the like. Each node may use the mathematical function to compute an output based on one or more inputs from nodes in other layer(s) (e.g., previous layer(s)) of the neural network. All or some of the nodes of the neural network may correspond to the same or a different mathematical function.

The neural network may include electronic data, such as, for example, a software program, code of the software program, libraries, applications, scripts, or other logic or instructions for execution by a processing device, such as circuitry. The neural network may be implemented using hardware including a processor, a microprocessor (e.g., to perform or control the performance of one or more operations), a field-programmable gate array (FPGA), or an application-specific integrated circuit (ASIC). Alternatively, in some embodiments, the neural network may be implemented using a combination of hardware and software. Accordingly, in some embodiments, the machine learning model 112 may be a separate entity in the system 102, without deviation from the scope of the disclosure. The machine learning model 112 may be configured to receive the obtained first information and the obtained second information as an input from the system 102.

The machine learning model 112 may further generate the output indicative of the soiling loss associated with the set of solar panels 106 of the PV power plant 104. The output may then be utilized by the system 102 to determine the soiling loss associated with the set of solar panels 106 of the PV power plant 104. Examples of the machine learning model 112 may include, but are not limited to, an artificial neural network (ANN), a deep neural network (DNN), a convolutional neural network (CNN), a fully connected neural network, and/or a combination of such networks.

The user device 114 may include suitable logic, circuitry, interfaces, and/or code that may be configured to output the rendered alert. The user device 114 may be configured to output the alert rendered by the system 102 based on the determined soiling loss. The alert may be displayed to the user 120 for cleaning the set of solar panels 106. In this context, the user device 114 may include suitable components, for example, at least, but not limited to, a user interface, to display the rendered alert as a notification based on the determined soiling loss associated with the set of solar panels 106 of the PV power plant 104. The notification may be displayed to the user 120 via the user device 114 for cleaning the set of solar panels 106. The user device 114 may further be utilized by the system 102 to display the output of the machine learning model 112. Examples of the user device 114 may include, but are not limited to, a computing device, a smartphone, a cellular phone, a mobile phone, a mainframe machine, a server, a computer workstation, and/or a consumer electronic (CE) device.

The communication network 116 may be wired, wireless, or any combination of wired and wireless communication networks, such as cellular, Wi-Fi, internet, local area networks, or the like. In some embodiments, the communication network 116 may include one or more networks such as a data network, a wireless network, a telephony network, or any combination thereof. It is contemplated that the data network may be any local area network (LAN), metropolitan area network (MAN), wide area network (WAN), a public data network (e.g., the Internet), short range wireless network, or any other suitable packet-switched network, such as a commercially owned, proprietary packet-switched network, e.g., a proprietary cable or fiber-optic network, and the like, or any combination thereof. In addition, the wireless network may be, for example, a cellular network and may employ various technologies including enhanced data rates for global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., worldwide interoperability for microwave access (WiMAX), Long Term Evolution (LTE) networks (for e.g. LTE-Advanced Pro), 5G New Radio networks, ITU-IMT 2020 networks, code division multiple access (CDMA), wideband code division multiple access (WCDMA), wireless fidelity (Wi-Fi), wireless LAN (WLAN), Bluetooth, Internet Protocol (IP) data casting, satellite, mobile ad-hoc network (MANET), and the like, or any combination thereof.

The sensor data 118 may include the data generated by the set of sensors 108 associated with the set of solar panels 106 of the PV power plant 104. The sensor data 118 may include the real-time operating parameters associated with the PV power plant 104. In this context, the sensor data 118 may include for example, but not limited to, the operational current paraments and the operational voltage parameters of the set of solar panels 106 of the PV power plant 104, the internal temperature of the inverter associated with the PV power plant 104, and the tilt angle of one or more trackers associated with the set of solar panels 106 of the PV power plant 104. The tilt angle may be one of but not limited to, for example, 20 degrees towards south, 25 degrees towards east, 25 degrees towards west or 30 degrees towards north-east. The one or more trackers may be the one or more devices associated with the set of solar panels 106 that allow solar panels to follow the path of the sun in the sky, thereby maximizing the production of energy by the PV power plant. Examples of each tracker of the one or more trackers may include one of a fix tilt tracker, a single axis tracker, a dual axis tracker, or a multi-axis tracker.

In operation, the system 102 may be configured to obtain the first information. The first information may include the location information associated with the set of solar panels 106 of the photovoltaic (PV) power plant 104 and the configuration information associated with the set of solar panels 106 of the PV power plant 104. The location information may refer to information associated with the location of the installation of the set of solar panels 106 of the PV power plant 104. The location information may include, for example, but not limited to, geographical coordinates of the installation site and an altitude of the installation site of the PV power plant 104. The configuration information associated with the set of solar panels 106 may refer to an information associated with an arrangement of the set of solar panels 106 within the PV power plant 104. The configuration information may include for example, but not limited to, an orientation of the set of solar panels 106 and an electrical configuration of the set of solar panels 106. The orientation of the set of solar panels 106 may refer to an orientation of installment of each solar panel of the set of solar panels 106. The electrical configuration of the set of solar panels 106 may include at least one of, but not limited to, a series configuration or a parallel configuration.

Thereafter, the system 102 may be configured to obtain the second information based on the obtained first information. The second information may include the real-time operating parameters associated with the PV power plant 104. The second information may be obtained from the set of sensors 108. Each sensor of the set of sensors 108 may be associated with the PV power plant 104. The real-time operational parameters may refer to real-time operational parameters of one or more components associated with the PV power plant 104. In an exemplary embodiment, the real-time operational parameters may include the operational current parameters associated with the set of solar panels 106 and the operational voltage parameters associated with the set of solar panels. In this context, the system 102 may be configured to obtain the operational current parameters from the set of current measuring sensors and the operational voltage parameters from the set of voltage measuring sensors.

Further, the system 102 may be configured to provide the obtained first information and the obtained second information as an input to the machine learning (ML) model 112. The ML model 112 may be a pre-trained model. The ML model 112 may be configured to predict the output indicative of the soiling loss associated with the set of solar panels 106 based on the first information and the second information. Further, the system 102 may determine the soiling loss associated with the set of solar panels 106 based on the output of the ML model 112. In an example, the system 102 may determine the soiling loss associated with each of the first solar panel 106A, the second solar panel 106B, up to the Nth solar panel 106N based on the output generated by the ML model 112. In this context, the output of the ML model may be indicative of the soiling loss associated with each of the first solar panel 106A, the second solar panel 106B, up to the Nth solar panel 106N.

The system 102 may be further configured to render the alert based on the determined soiling loss. The system 102 may be configured to render the alert as a notification on the user device 114 associated with the user 120 for cleaning the set of solar panels 106. The system 102 may render the alert when the determined soiling loss may be greater than a pre-determined threshold loss indicating that immediate cleaning of the set of solar panels 106 may be required. The user 120 may then clean the set of solar panels 106 based on the alert rendered on the user device 114. In an example, the pre-determined threshold loss may be for example, but not limited to, 20% decrease in performance of the PV power plant 104 due to soiling loss. The user 120 may correspond to an operator associated with the PV power plant 104. The operator may be assigned a task to clean the set of solar panels 106 based on the rendered alert. In an alternate embodiment, the system 102 may further generate one or more instructions associated with cleaning tasks of each solar panel of the set of solar panels 106. The one or more instructions may include one or more software instructions associated with performing the cleaning tasks which may be further transmitted to a set of robots for performing the cleaning tasks of the set of solar panels 106 based on the determined soiling loss. Each of the set of robots may include one of, for example, but not limited to, a utility-scale robotic cleaner, a commercial robotic cleaner, or a residential robotic cleaner.

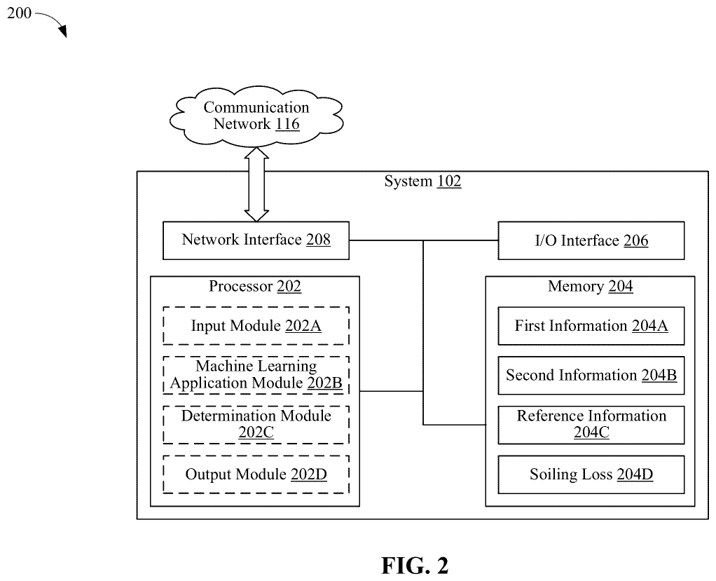

FIG. 2 illustrates a block diagram 200 of the system of FIG. 1, in accordance with an embodiment of the disclosure. FIG. 2 is explained in conjunction with FIG. 1. In FIG. 2, there is shown the block diagram 200 of the system 102. The system 102 may include at least one processor 202 (referred to as a processor 202, hereinafter), at least one non-transitory memory 204 (referred to as a memory 204, hereinafter), an input/output (I/O) interface 206, and a network interface 208. The processor 202 may include modules, depicted as, an input module 202A, a machine learning model application module 202B, a determination module 202C, and an output module 202D. The processor 202 may be connected to the memory 204, and the I/O interface 206 through wired or wireless connections. Although in FIG. 2, it is shown that the system 102 includes the processor 202, the memory 204, and the I/O interface 206 however, the disclosure may not be so limiting and the system 102 may include fewer or more components to perform the same or other functions of the system 102. In an embodiment, the input module 202A and the output module 202D may be integrated within the I/O interface 206. In some embodiments, the input module 202A may receive input data (such as user inputs) and the output module 202D may produce outputs via the I/O interface 206.

In accordance with an embodiment, the system 102 may store data that may be generated by the modules while performing corresponding operations or may be retrieved from a database associated with the system 102, such as the one or more databases 110, or in the memory 204. For example, the data may include a first information 204A, a second information 204B, a reference information 204C, and a soiling loss 204D.

The processor 202 of the system 102 may be configured to obtain the first information 204A, obtain the second information 204B, input the obtained first information and the obtained second information to the ML model 112, determine the soiling loss 204D based on the output of ML model 112 and render the alert based on the determined soiling loss 204D. The processor 202 may be embodied as one or more of various hardware processing means such as a coprocessor, a microprocessor, a controller, a digital signal processor (DSP), a processing element with or without an accompanying DSP, or various other processing circuitry including integrated circuits such as, for example, an ASIC (application-specific integrated circuit), an FPGA (field programmable gate array), a microcontroller unit (MCU), a hardware accelerator, a special-purpose computer chip, or the like. As such, in some embodiments, the processor 202 may include one or more processing cores configured to perform independently. A multi-core processor may enable multiprocessing within a single physical package. Additionally, or alternatively, the processor 202 may include one or more processors configured in tandem via the bus to enable independent execution of instructions, pipelining, and/or multithreading. Additionally, or alternatively, the processor 202 may include one or more processors capable of processing large volumes of workloads and operations to provide support for big data analysis. In an example embodiment, the processor 202 may be in communication with the memory 204 via a bus for passing information among components of the system 102.

For example, when the processor 202 may be embodied as an executor of software instructions, the instructions may specifically configure the processor 202 to perform the algorithms and/or operations described herein when the instructions are executed. However, in some cases, the processor 202 may be a processor-specific device (for example, a mobile terminal or a fixed computing device) configured to employ an embodiment of the present disclosure by further configuration of the processor 202 by instructions for performing the algorithms and/or operations described herein. The processor 202 may include, among other things, a clock, an arithmetic logic unit (ALU), and logic gates configured to support the operation of the processor 202. The network environment, such as 100 may be accessed using the network interface 208 of the system 102. The network interface 208 may provide an interface for accessing various features and data stored in the system 102.

In some embodiments, the processor 202 may be configured to provide Internet-of-Things (IoT) related capabilities to users of the system 102 disclosed herein. The I/O interface 206 may provide an interface for accessing various features and data stored in the system 102. By incorporating these IoT related capabilities, for example, but not limited to include, real-time monitoring and data collection, performance optimization, remote access and control, and security and asset protection into the system 102 to improve the efficiency, reliability, and profitability of the solar energy systems, contributing to the overall growth and adoption of solar panel. The I/O interface 206 may provide the user interface for communication of the system 102 with the user.

The input module 202A of the processor 202 may be configured to obtain the first information 204A associated with the set of solar panels 106 of the PV power plant 104. The first information 204A may include the location information associated with the set of solar panels 106 of the PV power plant 104 and configuration information associated with the set of solar panels 106 of the PV power plant 104. In another embodiment, the input module 202A may be configured to obtain the second information 204B from the set of sensors 108 associated with the set of solar panels 106 of the PV power plant 104. The second information 204B may include the real-time operating parameters associated with the PV power plant 104. In an exemplary embodiment, the input module 202A may be configured to obtain the operational current parameter from the set of current measuring sensors of the set of sensors 108 associated with the set of solar panels 106. In an alternate exemplary embodiment, the input module 202A may be configured to obtain the operational voltage parameter from the set of voltage measuring sensors of the set of sensors 108.

In additional embodiments, the input module 202A may be configured to obtain the reference information 204C associated with the set of solar panels 106 from one or more sources based on the obtained second information 204B. The reference information 204C may include at least one of a commissioning date associated with the set of solar panels and the pre-determined threshold loss. The commissioning date of a solar panel of the set of solar panels 106 may refer to a date when the set of solar panels 106 may be installed or connected to the grid for energy production. The pre-determined threshold loss may correspond to a value up to which the soiling loss 204D may be ignored or may be considered insignificant. In an example, the commissioning date and the pre-determined threshold loss may be obtained via a user input from the user device 114. In an embodiment, the input module 202A may obtain the user input provided by the user 120 via the user device 114. The user 120 may change the value of the pre-determined threshold loss as desired.

The machine learning application module 202B of the processor 202 may be configured to apply the machine learning model 112 on the first information 204A, the second information 204B and the reference information 204C to generate the output. In an embodiment, the system 102 may provide the obtained first information 204A, the obtained second information 204B and the obtained reference information 204C to the machine learning model 112 as an input. The machine learning model 112 may then predict the output. The output may be indicative of the soiling loss 204D associated with the set of solar panels 106 of the PV power plant 104.

Specifically, the output of the machine learning model 112 may be a diagnostic chart indicative of one of an increase in the soiling loss 204D over a first time period, a decrease in the soiling loss 204D over the first time period, or no change in the soiling loss 204D over the first time period. The first time period may refer to a fixed time frame between two consecutive cleaning cycles of the set of solar panels 106. The first time period may be for example, but not limited to, 1 day, 2 days, or 3 days. In an exemplary embodiment, the first time period may be lesser than a predefined threshold, for example, 5 days or a week. The first time period may be kept lesser than the predefined threshold in order to minimize the effects of other internal or external losses on the set of solar panels 106, which may help in determining the losses caused to the set of solar panels 106, primarily due to the soiling loss 204D. For example, an internal loss may correspond to a failure of some component of the PV power plant 104 whereas the external loss may correspond to a loss that may be caused by any external agent. For example, the external loss may include damage caused to the set of solar panels 106 due to some carelessness of a worker associated with the PV power plant 104 or a natural calamity.

The determination module 202C of the processor 202 configured to determine the soiling loss 204D based on the output of the ML model 112. In an exemplary embodiment, the system 102 may be configured to provide the first information 204A, the second information 204B and the reference information 204C, each of which may be obtained the first time period to the machine learning model 112. The machine learning model 112 may generate the diagnostic chart indicative of, for example, the increase in soiling loss for the first time period. In this context, the determination module 202C may determine the soiling loss 204D based on calculation of a gradient of a curve depicting the increase in soiling loss 204D in the diagnostic chart. The determined soiling loss 204D may then further be used to schedule further cleaning cycles of the set of solar panels 106.

The output module 202D of the processor 202 may be configured to render the alert for cleaning the set of solar panels 106 based on the determined soiling loss 204D. The output module 202D may be configured to output the alert based on the determined soiling loss 204D associated with the set of solar panels 106. The alert may be rendered on the user device 114 for the user 120 for cleaning the set of solar panels 106. In an exemplary embodiment, the machine learning model 112 may output the diagnostic chart based on the first information 204A, the second information 204B and the reference information 204C. In this context, the output module 202D may be configured to render the diagnostic chart for performing the cleaning tasks of each solar panel of the set of solar panels 106. In an alternate embodiment, the machine learning model 112 may predict a cleaning schedule of the set of solar panels 106. In that context, the output module 202D may output the cleaning schedule based on the determined soiling loss 204D.

The memory 204 of the system 102 may be configured to store the first information 204A, the second information 204B, the reference information 204C and the soiling loss 204D. The memory 204 may be non-transitory and may include, for example, one or more volatile and/or non-volatile memories. In other words, for example, the memory 204 may be an electronic storage device (for example, a computer readable storage medium) including gates configured to store data (for example, bits) that may be retrievable by a machine (for example, a computing device like the processor 202). The memory 204 may be configured to store information, data, content, applications, instructions, or the like, for enabling the system 102 to carry out various functions in accordance with an example embodiment of the present disclosure. For example, the memory 204 may be configured to buffer input data for processing by the processor 202. As exemplarily illustrated in FIG. 2, the memory 204 may be configured to store instructions for execution by the processor 202. As such, whether configured by hardware or software methods, or by a combination thereof, the processor 202 may represent an entity (for example, physically embodied in circuitry) capable of performing operations according to an embodiment of the present disclosure while configured accordingly. Thus, for example, when the processor 202 is embodied as an ASIC, FPGA, or the like, the processor 202 may be specifically configured hardware for conducting the operations described herein.

The first information 204A may include the location information associated with the set of solar panels 106 of the PV power plant 104 and configuration information associated with the set of solar panels 106 of the PV power plant 104. The location information may correspond to the information associated with the location of installment of the set of solar panels 106. The location information may include, for example, but not limited to, the geographical coordinates of the installation site and the altitude of the installation site of the PV power plant 104. The configuration information may correspond to the information associated with the arrangement of the components associated with the set of solar panels 106. The configuration information may include for example, but not limited to, the orientation of the set of solar panels 106, a type of solar panel, dimensions of the set of solar panels 106, the electrical configuration of the set of solar panels 106, and the like. The orientation of the set of solar panels 106 may refer to the orientation of installment of each solar panel of the set of solar panels 106. The electrical configuration of the set of solar panels 106 may include at least one of, but not limited to, the series configuration or the parallel configuration.

In an embodiment, the first information 204A may further include the real-time weather information associated with the location of installation of the set of solar panels 106. In an embodiment, the real-time weather information associated with the location of the set of solar panels 106 may include at least one of solar irradiance at the location of the set of solar panels 106, a wind speed at the location of the set of solar panels 106, a wind direction at the location of the set of solar panels 106, an ambient temperature at the location of the set of solar panels 106, solar irradiance at a front plane of the set of solar panels, solar irradiance at a rear plane of the set of solar panels 106, a temperature of the set of solar panels 106, a rainfall measurement at location of the set of solar panels 106, or a humidity at the location of the set of solar panels 106.

The solar irradiance at the location of the set of solar panels 106 corresponds to intensity of light at the location of the set of solar panels 106. The ambient temperature refers to the real time air temperature at the location of the set of solar panels 106. In one or more examples, the solar irradiance of the location of the set of solar panels may be for example, but not limited to, 7 kWh/m² per day. The ambient temperature may be for example, but not limited to, 35 degrees Celsius. The wind speed may be for example, but not limited to, 6 miles per hour. The wind direction may be for example, but not limited to, the north-east. The temperature of the solar panels may be for example, but not limited to, 35 degrees Celsius. The humidity at the location of the set of solar panels 106 may be for example, but not limited to, 34%. In an embodiment, the system 102 may be configured to obtain the real-time weather information of the location from one or more sources that may include at least a real-time satellite-based weather monitoring system. The system 102 may further obtain the rainfall measurement at the location of set of solar panels 106 from the set of precipitation measuring sensors of the set of sensors 108.

The second information 204B may include the real-time operating parameters associated with the PV power plant 104. In an embodiment, the real-time operating parameters may include the operational current parameter associated with the set of solar panels 106, the operational voltage parameter associated with the set of solar panels 106, the tilt angle of the one or more trackers associated with the set of solar panels 106, and the internal temperature of the inverter associated with the PV power plant 104. In an embodiment, the real-time operating parameters may be obtained from the set of sensors 108. Accordingly, the set of sensors 108 may include, for example, but not limited to, the set of current measuring sensors, the set of voltage measuring sensors, the set of motion sensors, and the set of temperature measuring sensors as described in FIG. 1.

The reference information 204C may include at least one of the commissioning date associated with the set of solar panels 106 and the pre-determined threshold loss. The pre-determined threshold loss associated with the set of solar panels 106 may include a specific allowable soiling loss value and/or rate. The commissioning date of a solar panel of the set of solar panels 106 may refer to the date when the corresponding solar panel may be installed or connected to the grid for energy production by the PV power plant 104. The pre-determined threshold loss may correspond to the value up to which the soiling loss 204D may be ignored or may be considered insignificant. In an example, the reference information 204C may be obtained from the user 120 via the user device 114.

The soiling loss 204D may include the determined soiling loss associated with the set of solar panels 106 of the PV power plant 104. The soiling loss 204D may correspond to the reduction in energy output from the set of solar panels 106 due to the accumulation of dirt, dust, pollen, bird droppings, and other debris on their surfaces. The impacts of soiling loss 204D may include reduced energy output, financial losses, increased maintenance costs, and the like. In an embodiment, the soiling loss 204D may be indicated by the diagnostic chart. In an embodiment, the output of the ML model 112 may be the diagnostic chart indicative of one of the increase in the soiling loss 204D over the first time period, the decrease in soiling loss 204D over the first time period and no change in the soiling loss 204D over the first time period. The soiling loss 204D may further include a distributed soiling loss over each solar panel of the set of solar panels 106 of the PV power plant 104. The soiling loss 204D may be utilized by the system 102 to render the alert for scheduling the cleaning tasks of each solar panels of the set of solar panels 106 associated with the PV power plant 104. The soiling loss 204D may further be utilized by the system 102 to determine a cleaning schedule for each solar panel of the set of solar panels 106.

In some example embodiments, the I/O interface 206 may communicate with the system 102 and display the input and/or output of the system 102. As such, the I/O interface 206 may include a display and, in some embodiments, may also include a keyboard, a mouse, a joystick, a touch screen, touch areas, soft keys, one or more microphones, a plurality of speakers, or other input/output mechanisms. In one embodiment, the system 102 may include a user interface circuitry configured to control at least some functions of one or more I/O interface elements such as a display and, in some embodiments, a plurality of speakers, a ringer, one or more microphones and/or the like. The processor 202 and/or I/O interface 206 circuitry including the processor 202 may be configured to control one or more functions of one or more I/O interface 206 elements through computer program instructions (for example, software and/or firmware) stored on a memory 204 accessible to the processor 202.

The network interface 208 may include input interface and output interface for supporting communications to and from the system 102 or any other component with which the system 102 may communicate. The network interface 208 may be any means such as a device or circuitry embodied in either hardware or a combination of hardware and software that is configured to receive and/or transmit data to/from a communications device in communication with the system 102. In this regard, the network interface 208 may include, for example, an antenna (or multiple antennae) and supporting hardware and/or software for enabling communications with a wireless communication network. Additionally, or alternatively, the network interface 208 may include the circuitry for interacting with the antenna(s) to cause transmission of signals via the antenna(s) or to handle receipt of signals received via the antenna(s). In some environments, the network interface 208 may alternatively or additionally support wired communication. As such, for example, the network interface 208 may include a communication modem and/or other hardware and/or software for supporting communication via cable, digital subscriber line (DSL), universal serial bus (USB) or other mechanisms.

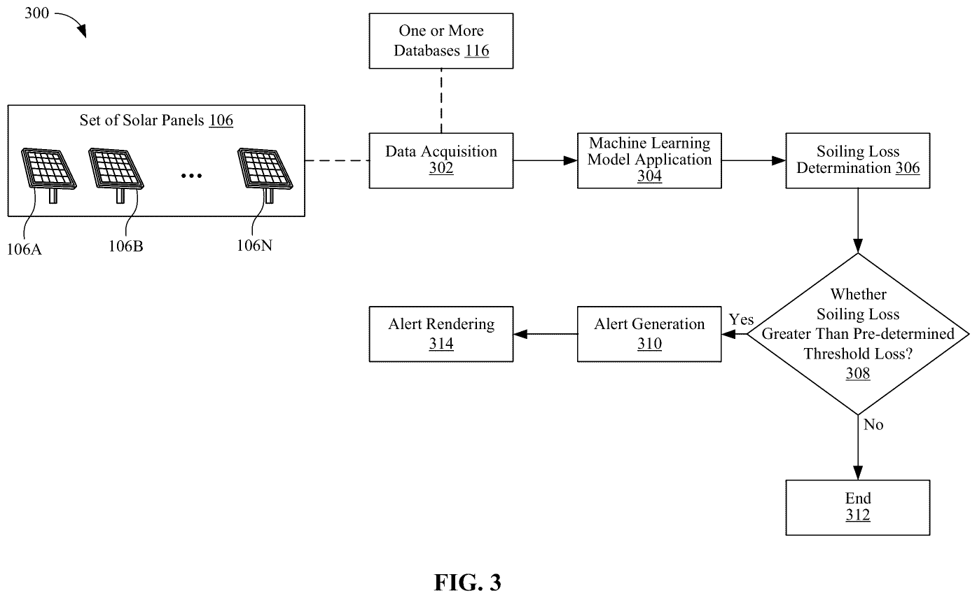

FIG. 3 is a block diagram 300 that illustrates exemplary operations for determination of soiling loss on the set of solar panels 106 of the PV power plant 104, in accordance with an embodiment of the disclosure. FIG. 3 is explained in conjunction with elements from FIG. 1 and FIG. 2. With reference to FIG. 3, there is shown the block diagram 300 that illustrates exemplary operations from 302 to 312, as described herein. The exemplary operations illustrated in the block diagram 300 may start at 302 and may be performed by any computing system, apparatus, or device, such as by the system 102 of FIG. 1 or the processor 202 of FIG. 2. Although illustrated with discrete blocks, the exemplary operations associated with one or more blocks of the block diagram 300 may be divided into additional blocks, combined into fewer blocks, or eliminated, depending on the implementation.

At 302, a data acquisition operation may be performed. In an embodiment, the system 102 may be configured to obtain the first information 204A. The first information 204A may include the location information associated with the set of solar panels 106 of the PV power plant 104 and the configuration information associated with the set of solar panels 106 of the PV power plant 104. The location information may include, for example, but not limited to, the geographical coordinates of the installation site of the PV power plant 104 and an altitude of the installation site of the PV power plant 104. The configuration information may include for example, but not limited to, the orientation of the set of solar panels 106 and the electrical configuration of the set of solar panels 106. The orientation of the set of solar panels 106 may refer to the orientation of installment of each solar panel of the set of solar panels 106.

In an example, the system 102 may obtain the geographical co-ordinates of the location of installation of the set of solar panels 106. In another example, the system 102 may obtain the location information from a map database or a satellite-based global positioning system (GPS). The system 102 may further obtain the configuration information that may include an orientation of each solar panel of the set of solar panels 106. The orientation of the solar panel may indicate a direction of the corresponding solar panel. The orientation may be for example, but not limited to, 30 degrees north-east. In one or more examples, the system 102 may obtain the configuration information via the user input.

In an embodiment, the system 102 may be configured to obtain the real-time weather information of the location of installation of the set of solar panels 106. The real-time weather information may include at least one of the solar irradiance at the location of the set of solar panels 106, the wind speed at the location of the set of solar panels 106, the wind direction at the location of the set of solar panels 106, the ambient temperature at the location of the set of solar panels 106, the solar irradiance at the front plane of the set of solar panels 106, the solar irradiance at the rear plane of the set of solar panels 106, the temperature of the set of solar panels 106, the rainfall measurement at the location of the set of solar panels 106, or the humidity at the location of the set of solar panels 106.

The real-time weather information may be obtained, for example, using the real-time satellite-based weather monitoring systems. In an example, the system 102 may be configured to perform the data acquisition operation to obtain the real-time wind speed of the location of installation of the set of solar panels 106 from the real-time satellite-based weather monitoring systems. The system 102 may obtain a wind speed of, for example, 10 miles per hour at the location of installation of the set of solar panels 106. The system 102 may further obtain the rainfall (precipitation) measurements from the set of sensors 108.

In an embodiment, the system 102 may further be configured to obtain the second information 204B. The second information 204B may include the real-time operating parameters of the PV power plant 104. The real-time operating parameters may include real-time operational current parameter associated with the set of solar panels 106, real-time operational voltage parameter associated with the set of solar panels 106, real-time tilt angle of the one or more trackers associated with the set of solar panels 106, and real-time internal temperature of the inverter associated with the PV power plant 104. In an embodiment, the second information 204B may be obtained from the set of sensors 108.

In an example, the system 102 may be configured to obtain the operational voltage parameter associated with the set of solar panels 106 from the set of voltage measuring sensors. The system 102 may further obtain the operational current parameter associated with the set of solar panels 106 from the set of current measuring sensors. The system 102 may further obtain the internal temperature of the inverter associated with the PV power plant 104 from the set of temperature measuring sensors. The internal temperature may be for example, but not limited to, 40 degrees Celsius. The system 102 may further obtain the tilt angle of the one or more trackers from the set of motion sensors. The tilt angle may be one of but not limited to, for example, 20 degrees towards south, 25 degrees towards east, 25 degrees towards west or 30 degrees towards north-east. Examples of each of the one or more trackers may include one of, but not limited to, a fix tilt tracker, a single axis tracker, a dual axis tracker, or a multi-axis tracker.

In another embodiment, the second information 204B associated with the set of solar panels 106 may be constrained with respect to the first time period and may be obtained from the sensor data 118 collected by the set of sensors 108. The set of sensors 108 associated with the set of solar panels 106 may continuously measure the real-time operating parameters during the first time period and the system 102 may continuously obtain the real-time operating parameters from the set of sensors 108. With time, the performance of components of the PV power plant 104 may gradually decrease with passage of time due to usage. Therefore, there may be a need to obtain the real-time operating parameters to determine a real-time performance of the set of solar panels 106 of the PV power plant 104.

In an additional embodiment, the system 102 may be configured to obtain cleaning frequency data associated with the set of solar panels 106. The cleaning frequency data may include information associated with a cleaning frequency of the set of solar panels 106. The cleaning frequency data may be obtained from one or more sources. In an exemplary embodiment, the cleaning frequency data may be obtained from the user 120 as the user input via the user device 114. In an alternate exemplary embodiment, the cleaning frequency data may be obtained based on a textual analysis of the data included in manual cleaning logbooks that may be associated with the cleaning of the set of solar panels 106. Such manual cleaning logbooks may correspond to handwritten notes indicating a date and time of the cleaning of the set of solar panels 106 by the set of operators. In yet another alternate exemplary embodiment, the cleaning frequency data may be obtained from the set of robots associated with performing the cleaning tasks of the set of solar panels 106.

In another embodiment, the system 102 may be configured to obtain the reference information 204C associated with the set of solar panels 106 from one or more sources. The reference information 204C may include at least one of the commissioning date associated with the set of solar panels 106 and the pre-determined threshold loss as described in FIG. 2. In an exemplary embodiment, the system 102 may obtain the reference information 204C from the user 120 via the user input. The user 120 may provide the user input via the user device 114. In an example, the reference information 204C may include a reference electric power generated by the PV power plant 104. The reference electric power may include power generated by each solar panel of the set of solar panel 106 on the commissioning date. The electric power generated by each solar panel of the set of solar panels 106 may be, for example, 100 watts.

In another embodiment, the system 102 may be configured to validate the first information 204A and the second information 204B associated with the set of solar panels 106. The system 102 may validate the first information 204A and the second information 204B based on application of one or more data validation techniques. The data validation may refer to a process of ensuring the accuracy and quality of data and may be performed on the first information 204A and the second information 204B to identify and remove any kinds of inconsistencies and inaccuracies. The validated first information 204A and the validated second information 204B may then be stored into the one or more databases 110 for determining the soiling loss 204D.

The one or more data validation techniques may include for example, but not limited to, format checks and consistency checks. The format checks may refer to a procedure to check that a data format of the first information 204A and the data format of the second information 204B may be properly maintained. The consistency checks may refer to a procedure to identify and remove redundancies in the first information 204A and the second information 204B. For example, the system 102 may perform the format checks and consistency checks on the first information 204A and the second information 204B to check whether measurement units of the temperature of the set of solar panels 106 are consistent or not. For example, if the temperature obtained from the first sensor 108A may be in degree Celsius and the temperature obtained from the second sensor 108B may be in degree Kelvin, then the system 102 may be configured to convert the temperature obtained in degrees Kelvin to degree Celsius to maintain consistency.

In another embodiment, the system 102 may be configured to normalize the validated first information 204A and the validated second information 204B. The process of data normalization may include organizing data to appear similar across all records and fields. The system 102 may be configured to perform the normalization of the validated first information 204A and the validated second information 204B to organize the validated first information 204A and the validated second information 204B based on application of the one or more normalization techniques, which may include, for example, but not limited to, decimal place normalization technique, data type normalization technique, and Z-score normalization technique. The system 102 may then be configured to store the normalized data in the one or more databases 110. Details about the data normalization techniques are known in the art and have been omitted for the sake of brevity.

At 304, the machine learning model application operation may be performed. In the machine learning application operation, the system 102 may apply the machine learning model 112 on the first information 204A, the second information 204B and the reference information 204C to predict the output. The machine learning model 112 may perform predictive analysis on the obtained first information 204A, the obtained second information 204B and the obtained reference information 204C and generate the output indicative of the soiling loss 204D associated with the set of solar panels 106. In an embodiment, the system 102 may provide the validated first information, the validated second information and the real-time weather information to the machine learning model 112 The system 102 may be configured to apply the ML model 112 on the validated first information 204A, the validated second information 204B and the real-time weather information to predict the output indicative of the soiling loss 204D.

In an additional embodiment, the system 102 may apply the ML model 112 on the first information 204A, the second information 204B and the reference information 204C based on the obtained cleaning frequency data. As an example, the system 102 may apply the ML model 112 on the days between two consecutive cleaning cycles of the set of solar panels 106, which is the first time period. In this context, the system 102 may ensure that, at time zero (just after the set of solar panels 106 are cleaned), the obtained second information 204B may be associated with a cleaned state of the set of solar panels 106. Specifically, the system 102 may ensure that operational current, the operational voltage and operational power of the set of solar panels 106 at the time zero corresponds to the operational current, the operational voltage and operational power just after the set of solar panels 106 are cleaned. Then, the ML model 112 may predict the soiling loss 204D during the first time period (between the consecutive cleaning cycles) based on the captured first information 204A at a current time, the second information 204B at the current time, and the second information 204B associated with the cleaned state of the set of solar panels 106 at time zero after recent cleaning of the the set of solar panels 106.

In another embodiment, the output of the ML model 112 may be the diagnostic chart indicative of one of the increase in the soiling loss 204D for the first time period, the decrease in the soiling loss 204D for the first time period, or no change in the soiling loss 204D for the first time period. In an example, the ML model 112 may determine a change in performance of the PV power plant 104 during the first time period (between two consecutive cycles). The ML model 112 may predict the output based on the change in operational current and the change in operational voltage during the first time period and based on the real-time weather information. The ML model 112 may then predict the output based on the change in performance of the PV power plant 104.

In an exemplary scenario, the ML model 112 may determine the rainfall measurements at the location of the set of solar panels 106 during the first time period from the real-time weather information obtained from the set of sensors 108. This scenario may indicate that the dust accumulated on the set of solar panels 106 may be cleaned due to rainfall, then the output of the ML model 112 in such a scenario may indicate the decrease in soiling loss 204D and the system 102 may render the message that cleaning of the set of solar panels 106 may not be required urgently. In an alternate exemplary scenario, the ML model 112 may determine negligible amount of rainfall from the rainfall measurements of the location of the set of solar panels 106 during the first time period. Then, in such a scenario, the ML model 112 may predict the output indicative of the increase in soiling loss 204D over the first time period.

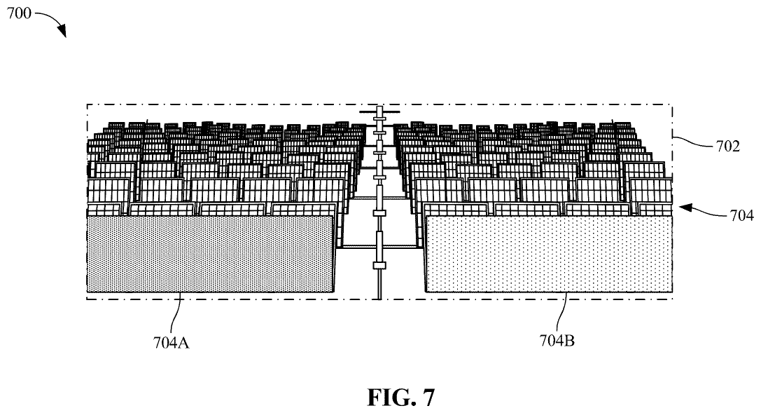

In another embodiment, the diagnostic chart may correspond to a heatmap associated with the PV power plant 104. The heatmap may indicate the distribution of soiling loss 204D over the PV power plant 104. Specifically, the heatmap may indicate the variation in soiling loss 204D over each solar panel of the set of solar panels 106 by a variation in intensity of color of one or more regions. The one or more regions in the heatmap may correspond to one or more solar panels of the set of solar panels 106 and the intensity of the color of the one or more solar panels may indicate the soiling loss of each of the one or more solar panels. Details about the heatmap are further provided in FIG. 7.

At 306, the soiling loss 204D determination operation 306 may be performed. In an embodiment, the system 102 may determine the soiling loss 204D associated with the set of solar panels 106 based on the output of the machine learning model 112. The soiling loss 204D may correspond to an amount of reduction in energy output from the set of solar panels 106 due to the accumulation of the dirt, the dust, or other debris on the surfaces of the set of solar panels 106. The impacts of soiling loss 204D may include financial losses which cause great damage to the PV power plant 104.

In an embodiment, the system 102 may calculate the determined soiling loss 204D based on the output of the machine learning model 112. The output of the ML model 112 may be the diagnostic chart indicative of one of the increase in the soiling loss 204D for the first time period, the decrease in the soiling loss 204D for the first time period, or no change in the soiling loss 204D for the first time period. In an example, the system 102 may calculate the gradient of the curve in the diagnostic chart to determine the soiling loss 204D.

The system 102 may determine the soiling loss 204D in terms of a percentage factor. The determined soiling loss 204D may be for example, but not limited to, 10%, 20%, or 30%. In one or more examples, the system 102 may also determine the soiling loss 204D based on a percentage of performance change of the PV power plant 104 due to the soiling loss 204D. The system 102 may calculate the percentage of performance change based on the output of the ML model 112. The percentage of performance change may be at least one of, for example, but not limited to, 10% decrease in performance of the PV power plant 104 as compared to an optimal or desired performance of the PV power plant.

At 308, it may be determined whether the soiling loss 204D is greater than the pre-determined threshold loss. In an embodiment, the system 102 may be configured to compare the determined soiling loss 204D with the pre-determined threshold loss. The determined soiling loss 204D may be for example, but not limited to, 10%, 20%, or 30%. In an example, the system 102 may compare the soiling loss 204D with the pre-determined threshold loss. For example, when the pre-determined threshold loss may be set to 20% and the determined soiling loss 204D is 30%, then the system 102 may determine that the soiling loss 204D may be greater than the pre-determined threshold loss by 10% and the control may be transferred to 310. Otherwise, the control may be transferred to end at 312.

At 310, an alert generation operation may be performed. In an embodiment, the alert generation operation may be performed based on the determined soiling loss 204D being greater than the pre-determined threshold loss. The system 102 may be configured to generate the alert when the determined soiling loss 204D may be greater than the pre-determined threshold loss. In an embodiment, the system 102 may render the alert based on the comparison. The system 102 may render the alert on the user device 114 for the user 120 to clean the set of solar panels based on when the determined soiling loss 204D may be greater than the pre-determined threshold loss.

At 312, based on the determined soiling loss 204D being less than the pre-determined threshold loss the operations of the block diagram 300 may end at 312.

At 314, the alert rendering operation may be performed. In the alert rendering operation, system 102 may render the generated alert on the user device 114 to notify the user 120 for performing the cleaning of the set of solar panels 106. The alert may be outputted to the user 120 via the user device 114. The alert may indicate the user 120 that soiling loss 204D may be greater than the pre-determined threshold loss and cleaning of the set of solar panels 106 may be required. The user 120 may then clean the set of solar panels 106 based on the rendered alert. In an embodiment, the generated alert may further include one or more instructions for the user 120 to clean the set of solar panels 106.

In another embodiment, the processor 202 of the system 102 may be configured to transmit the one or more instructions associated with cleaning of at least one solar panel of the set of solar panels 106 to a set of robots or a set of user devices based on the determined soiling loss 204D. In an embodiment, the set of user devices may be associated with a set of operators associated with the PV power plant 104. The set of operators may perform the cleaning of the set of solar panels 106 based on the one or more instructions. In one or more examples, the one or more instructions may include one or more software instructions for cleaning the set of solar panels 106 which may be executed by the set of robots. The set of robots may include one of, for example, but not limited to, a set of utility-scale robotic cleaner, a set of commercial robotic cleaners or a set of residential robotic cleaners.

In an exemplary embodiment, the user 120 may correspond to an operator of the set of operators who may clean the set of solar panels 106 of the PV power plant 104. Each of the set of operators may be informed to clean the set of solar panels 106 via the user device associated with the corresponding operator. In another example, the system 102 may transmit the one or more instructions to the set of robots to control the set of robots for automated cleaning of the set of solar panels 106 of the PV power plant 104. The set of robots may then perform the cleaning of the set of solar panels 106 based on the one or more instructions.

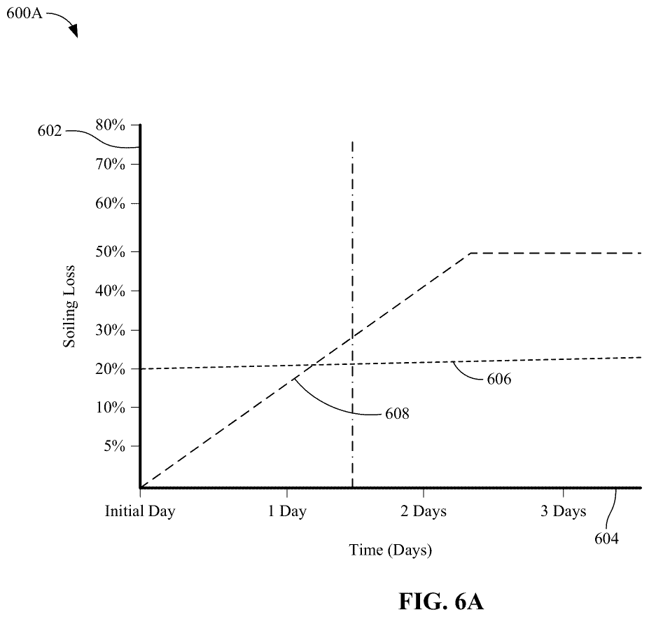

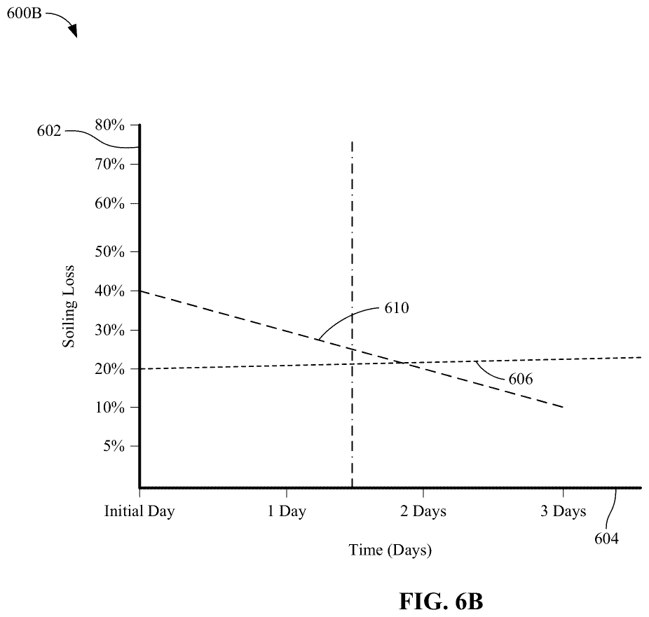

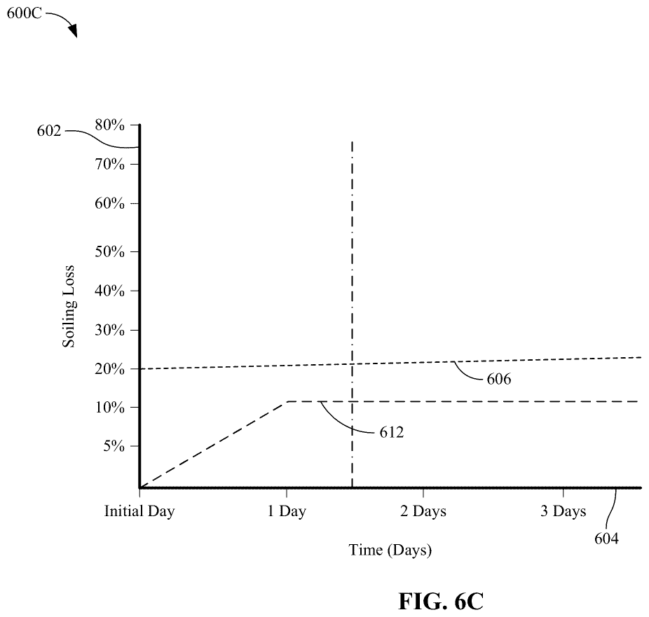

In another embodiment, the system 102 may be configured to render the output of the ML model 112 on the user device 114. Specifically, the system 102 may be configured to render the diagnostic chart depicting one of the increase in soiling loss 204D for the first time period, the decrease in soiling loss for the first time period, or no change in soiling loss for the first time period on the user device 114. Details about the diagnostic chart are further provided in FIG. 6A, FIG. 6B and FIG. 6C.

In another embodiment, the system 102 may further be configured to render the heatmap on the user device 114. The heatmap may be rendered on the user device 114 to indicate a distribution of the soiling loss over the entire PV power plant 104 to the user 120. In additional embodiment, the diagnostic chart may correspond to the heatmap associated with the PV power plant 104. The heatmap may further include the soiling loss 204D associated with each solar panel (such as the first solar panel 106A, the second solar panel 106B, and the Nth solar panel 106N) of the set of solar panels 106. Details about the heatmap are further explained in FIG. 7.

In one or more embodiments, the system 102 may be configured to render one or more charts on the user device 114. The one or more charts may include one or more cleaning schedules of each solar panel of the set of the solar panels 106. The system 102 may be configured to generate one or more charts indicating the one or more cleaning schedules of each solar panel of the set of solar panels 106. The one or more charts may be used for scheduling future cleaning cycles of set of solar panels 106 of the PV power plant 104. The one or more charts may include future cleaning schedules for cleaning the set of solar panels 106. The future cleaning schedules may be rendered on the user device 114 and the user 120 may use the future cleaning schedules to clean the set of solar panels 106 for a period of for example, upcoming 2 weeks.

The one or more charts may include the sequence order of cleaning each solar panels of the set of solar panels. For example, the one or more charts may include the sequence order from cleaning the first solar panel 106A as the first to be cleaned and the Nth solar panel 106N to be the last one to be cleaned. The one or more charts may be displayed to the user 120 via the user device 114 for cleaning each solar panel of the set of solar panels 106. The system 102 may further utilize the one or more charts to transmit the one or more instructions to the set of robots or the set of user device for cleaning the set of solar panels 106 according to the one or more cleaning schedules. In additional embodiments, the system 102 may be configured to generate the one or more charts indicative of the soiling loss 204D based on the obtained first information 204A, obtained second information 204B, the determined soiling loss 204D, and a training dataset associated with historical soiling loss events. The ML model 112 may be pre-trained on the training dataset.

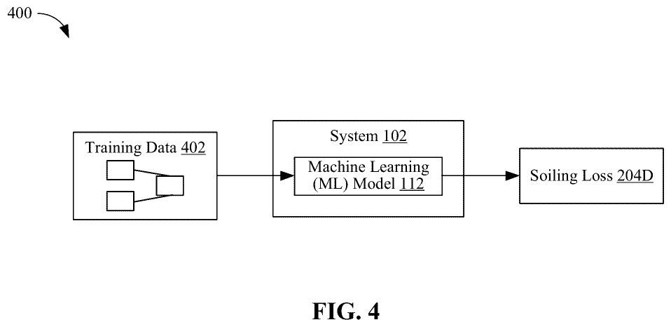

FIG. 4 is a block diagram that illustrates a block diagram depicting training an exemplary machine learning model on training data for determination of soiling loss, in accordance with an exemplary embodiment of the disclosure. FIG. 4 is explained in conjunction with elements from FIG. 1, FIG. 2 and FIG. 3. With reference to FIG. 4, there is shown the block diagram 400 including the system 102, the machine learning model 112, training data 402, and the soiling loss 204D.

The training data 402 may refer to a training dataset that may be associated with historical soiling loss events associated with the set of solar panels 106 of the PV power plant 104. The training dataset may be utilized by the system 102 to pre-train the machine learning model 112. The training data 402 may include input data and corresponding output data. The input data and the corresponding output data may be associated with historical soiling loss events associated with the set of solar panels 106 of the PV power plant 104 or any other power plant in the same region as that of the PV power plant 104. The output data may include the soiling loss 204D corresponding to the first information 204A, the second information 204B and the reference information 204C for each historical soiling loss event.

The system 102 may be configured to provide the training data 402 to the machine learning model 112. The machine learning model 112 may determine a machine learning algorithm for prediction of the soiling loss 204D based on the training data 402. In an exemplary embodiment, the machine learning model 112 may determine a mathematical representation of the relationship between the input data and the corresponding output data to determine the machine learning algorithm for determining the soiling loss 204D based on the first information 204A, the second information 204B and the reference information 204C. This process of feeding the machine learning algorithm with training data is referred to as model training. Details about the training of the machine learning model 112 is known in the art and has been omitted for the sake of brevity.

Based on the training data, the machine learning model 112 may be configured to predict the soiling loss 204D using the obtained first information 204A, the obtained second information 204B and the obtained reference information 204C. The machine learning model 112 may then be configured to predict the output, which may be indicative of the determined soiling loss 204D associated with the set of solar panels 106 based on the first information 204A, the second information 204B and the reference information 204C.

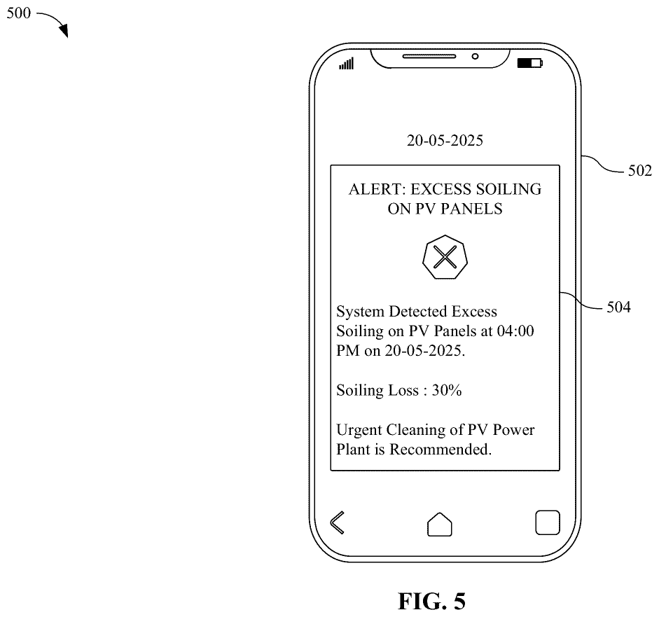

FIG. 5 is a diagram that illustrates an exemplary alert associated with the soiling loss, in accordance with an embodiment of the disclosure. FIG. 5 is explained in conjunction with FIG. 1, FIG. 2, FIG. 3, and FIG. 4. With reference to FIG. 5, there is shown an electronic device 502 that renders an alert 504 associated with the soiling loss. The electronic device 502 may be an exemplary embodiment of the user device 114 of FIG. 1.

The electronic device 502 may include suitable logic, circuitry, interfaces, and/or code to output the alert 504 that may be generated by the system 102. In an embodiment, the system 102 may be configured to determine the soiling loss associated with the PV power plant 104 and further output the alert 504 on the electronic device 502. The alert 405 may be indicative of the determined soiling loss. As shown in FIG. 5, the soiling loss due to excessive soling on the set of solar panels 106 may be 30%. In addition to the determined soiling loss, the system 102 may be further configured to include one or more recommendations to overcome or decrease the soiling loss. As shown in FIG. 5, the recommendation may be to urgently clean the set of solar panels 106.

In an embodiment, the alert 504 may be rendered as a notification on the electronic device 502 and may be indicative of the soiling loss 204D being greater than the pre-determined threshold loss. Furthermore, the alert 504 may notify the user 120 for cleaning of the solar panels 106 to maintain optimal performance and efficiency of the PV power plant 104. In an example, the alert 504 may include at least a message to the user 120 indicating the detected soiling loss 204D may be greater than the pre-determined threshold loss. In this context, the message may include, for example, a date on which the alert may be generated, and a time at which the alert may be generated.

In an alternate embodiment, the alert 504 may include the diagnostic charts generated by the machine learning model 112. In another embodiment, the system 102 may utilise the electronic device 502 to output the alert, the diagnostic chart, and the heatmap to the user 120 for cleaning the set of solar panels 106. In another embodiment, the alert 504 may further include the one or more charts generated by the system 102 which may depict the schedule for cleaning the set of solar panels 106.

FIG. 6A illustrates an exemplary first diagnostic chart as an output of the machine learning model, in accordance with an embodiment of the disclosure. FIG. 6A is explained in conjunction with FIG. 1, FIG. 2, FIG. 3, FIG. 4, and FIG. 5. With reference to FIG. 6A, there is shown a graphical representation 600A including a y-axis 602, an x-axis 604, a horizontal line 606, and a curve 608 indicative of the soiling loss over a period of time.

The y-axis 602 may correspond to the soiling loss 204D associated with the set of solar panels 106 of the PV power plant 104 with respect to time and may be measured in terms of the percentage factor. The efficiency of the set of solar panels 106 during the first time period (between two consecutive cleaning cycles) may be utilized by the system 102 to determine the soiling loss 204D. The efficiency may be determined based on the real-time operating parameters obtained during the first time period from the set of sensors 108. The soiling loss 204D may refer to the amount of reduction in power output of photovoltaic (PV) panels due to the accumulation of dust, dirt, and other particles on their surface. The soiling loss 204D may be determined based on the output of ML model 112, which may compare the efficiency of the cleaned set of solar panels corresponding to the efficiency at time zero and the efficiency of soiled set of solar panels corresponding to the efficiency after the time zero during or after the first time period.

The efficiency of the set of solar panels 106 may be determined for the first time period between the consecutive cleaning cycles. To determine the efficiency, considering the soiling loss 204D as the only factor and eliminating any other factors, the efficiency may be determined for the first time period which may be the time frame between two consecutive cleaning cycles and lesser than the predefined threshold. The first time period may be for example, but is not limited to, 1 day, 2 days, or 3 days. In an exemplary embodiment, the first time period may be less than the predefined threshold, for example, 4 days. The first time period may be lesser in order to minimize the effects of other internal or external losses on the set of solar panels 106, which may help in determining the losses caused to the set of solar panels 106, primarily due to the soiling loss 204D. For example, the internal loss may correspond to the failure of some component of the PV power plant 104. An external loss may correspond to the loss caused by the external agent. Details about the first time period are provided in FIG. 3.

The x-axis 604 may correspond to time (in days) over which the efficiency of the set of solar panels 106 of the PV power plant 104 may be determined. The initial point on the x-axis may represent the day when the set of solar panels 106 may be cleaned or may be connected with the grid for energy production. The initial point may correspond to a starting point for the soiling analysis.

The horizontal line 606 may correspond to the pre-determined threshold loss associated with the soiling loss 204D after which the system 102 may render the alert 504 on the user device 114. The pre-determined threshold loss may be set at for example, but not limited to, 20%, as depicted in the figure for this scenario. In an embodiment, the pre-determined threshold loss may be obtained in the reference information 204C by the system 102 as the user input as explained in FIG. 2 and FIG. 3.

In an embodiment, the curve 608 may correspond to the diagnostic chart indicative of the increase in the soiling loss 204D for the set of solar panels 106 over the first time period due to which the performance of the solar panels 106 may be decreased. In an exemplary embodiment, the curve 608 may indicate that the soiling loss 204D for the first time period may be greater than the pre-determined threshold loss and there is a need to clean the set of solar panels 106 of the PV power plant 104. The system 102 may render the alert on the user device 114 for the user 120 to clean the set of solar panels 106. The user 120 may clean the set of solar panels 106 to maintain the efficiency of the set of solar panels 106 of the PV power plant 104.

In one or more examples, the system 102 may further generate the heatmap indicating the distribution of the soiling loss 204D on each solar panel of the set of solar panels 106 to identify the solar panels which may require immediate cleaning and further generate a cleaning schedule for the set of solar panels 106 in the sequence order of decreasing soiling losses. In another embodiment, the system 102 may further generate the one or more charts for the cleaning schedules of the set of solar panels 106. Details about the one or more charts are provided in FIG. 3.

FIG. 6B illustrates an exemplary second diagnostic chart as an output of the machine learning model, in accordance with an embodiment of the disclosure, in accordance with an embodiment of the disclosure. FIG. 6B is explained in conjunction with FIG. 1, FIG. 2, FIG. 3, FIG. 4, FIG. 5, and FIG. 6A. With reference to FIG. 6B, there is shown a graphical representation 600B including the y-axis 602, the x-axis 604, the horizontal line 606, and a curve 610. Details about the y-axis 602, the x-axis 604, and the horizontal line 606 are provided in FIG. 6A.

In an embodiment, the curve 610 may correspond to the diagnostic chart indicative of the decrease in the soiling loss 204D for the set of solar panels 106 over the first time period. The curve 610 may indicate a potential issue with the data collected by the set of sensors 108 because of which the curve 610 may indicate the decrease in soiling loss 204D. Specifically, the decrease in soiling loss 204D or negative soiling loss 204D may indicate a malfunction in the set of sensors 108 linked with the set of solar panels 106 of the PV power plant 104. The negative soiling loss may also suggest a calibration issue associated with the set of sensors 108. In that case, the system 102 may render the message on the user device 114 to notify the user 120 to check the calibration of components and the set of sensors 108 or to replace the components and/or the set of sensors 108.

In an exemplary scenario, the ML model 112 may determine the rainfall measurements at the location of the set of solar panels 106 during the first time period from the real-time weather information obtained from the set of sensors 108. In such a scenario the dust accumulated on the set of solar panels 106 may be cleaned due to rainfall, thereby the output of the ML model 112 in such a scenario may indicate the decrease in soiling loss 204D and the system 102 may render the message that cleaning of the set of solar panels 106 may not be required urgently.

FIG. 6C illustrates an exemplary third diagnostic chart as an output of the machine learning model, in accordance with an embodiment of the disclosure, in accordance with an embodiment of the disclosure. FIG. 6C is explained in conjunction with FIG. 1, FIG. 2, FIG. 3, FIG. 4, FIG. 5, FIG. 6A, and FIG. 6B. With reference to FIG. 6C, there is shown a graphical representation 600C including the y-axis 602, the x-axis 604, the horizontal line 606, and a curve 612. Details about the y-axis 602, the x-axis 604, and the horizontal line 606 are provided in FIG. 6A.

In an embodiment, the curve 612 may correspond to the diagnostic chart indicative of the no change in the soiling loss 204D for the set of solar panels 106 of the PV power plant 104 over the first time period. A constant gradient of the graph is indicative of the soiling loss being less than the pre-determined threshold loss. In such a scenario, the system 102 may display the message on the user device 114 that the soiling loss 204D may be less than the pre-determined threshold, and cleaning of the set of solar panels 106 may not be urgently required.

FIG. 7 is a diagram that illustrates an exemplary heatmap depicting soiling loss on solar panels of the photovoltaic power plant, in accordance with an embodiment of the disclosure. FIG. 7 is explained in conjunction with FIG. 1, FIG. 2, FIG. 3, FIG. 4, FIG. 5, FIG. 6A, FIG. 6B, and FIG. 6C. With respect to FIG. 7, there is shown the diagram 700 including a PV power plant 702, and a heatmap 704 associated with the PV power plant 702. The heatmap 704 may further include a first region 704A and a second region 704B.

The heatmap 704 may indicate the distribution of soiling loss 204D over the PV power plant 702. The heatmap 704 may indicate the variation in soiling loss 204D over each solar panel of the set of solar panels 106 by the variation in intensity of color or patterns of the one or more regions. In an embodiment, the diagnostic chart may correspond to the heatmap 704 associated with the PV power plant 104. The heatmap 704 may indicate the distribution of the soiling loss 204D over the PV power plant 104. The heatmap 704 may further include the first region 704A and the second region 704B. The first region 704A may include a first set of solar panels on which the soiling loss may be greater than the pre-determined threshold loss and the second region 704B may include a second set of solar panels on which the soiling loss may be less than or equal to the pre-determined threshold loss.

In an embodiment, the first region 704A may include a greater intensity of colour (or a first pattern) in the heatmap 704 compared to the intensity of colour (or a second pattern) of the second region 704B. The greater intensity may indicate that the first set of solar panels of the PV power plant 104 corresponding to the first region may have comparatively greater soiling loss as compared to the second set of solar panels corresponding to the second region 704B. The heatmap 704 may further indicate that there may be a need for cleaning the first set of solar panels more frequently than the second set of solar panels.

By way of example and not limitation, the first set of solar panels may be facing towards a windy side of the PV power plant 104 due to more dust and dirt may get accumulated on the first set of solar panels as compared to the second set of solar panels. Due to this, there may be a need to clean the first set of solar panels more frequently as compared to the second set of solar panels to maintain the efficiency of the PV power plant 104. The system 102 may then generate the one or more charts indicating the cleaning schedules of the first set of solar panels more frequently than the second set of solar panels. Details about the one or more charts is provided in FIG. 3.

The second region 704B may have a lesser intensity of colour (or the second pattern) in the heatmap 704 as compared to the intensity of the first region 704A (or the first pattern). The lesser intensity may indicate that the second set of solar panels of the PV power plant 104 corresponding to the second region 704B may face comparatively lesser soiling loss as compared to the first set of solar panels corresponding to the first region 704A. In an example, the cleaning process of the second set of solar panels may be performed after comparatively greater time periods as compared with the first set of solar panels, to manage the economic assets of the PV power plant 104.

In an exemplary embodiment, the system 102 may generate one or more charts including the one or more cleaning schedules of the set of solar panels 106 of the PV power plant 104. The one or more cleaning schedules of the second set of solar panels may be generated less frequently as they may face comparatively less soiling loss as compared to the first set of solar panels. The one or more cleaning schedules may be displayed on the user device 114 for the user 120. The user 120 may follow the one or more cleaning schedules to clean the set of solar panels 106 of the PV power plant 104.

In another example, the one or more charts may be generated by the system 102 may indicate a sequence order of cleaning of the set of solar panels 106. The one or more charts may inform the user 120 to clean the first set of solar panels before the second set of solar panels. Further, the one or more charts may include an order of cleaning from the first solar panel 106A up to the Nth solar panel 106N based on the decreasing order of soiling loss 204D. For example, when the order of soiling loss 204D may decrease from the first solar panel 106A to the Nth solar panel 106N, then the system 102 may render the cleaning schedule in a descending order with cleaning the first solar panel 106A as a first task of the cleaning schedule to cleaning the Nth solar panel 106N as a final task of the cleaning schedule.

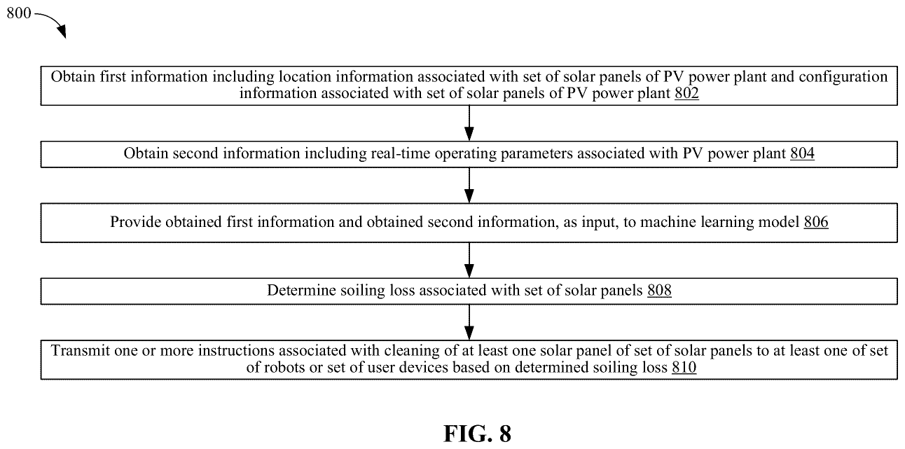

FIG. 8 is a flowchart 800 that illustrates a first exemplary method for determination of soiling loss on solar panels of the PV power plant 104, in accordance with an embodiment of the disclosure. FIG. 8 is explained in conjunction with FIG. 1, FIG. 2, FIG. 3, FIG. 4, FIG. 5, FIG. 6A, FIG. 6B, FIG. 6C, and FIG. 7. With reference to FIG. 8, there is shown the flowchart 800. The operations of the exemplary method may be executed by the system 102 of FIG. 1 or the processor 202 of FIG. 2. The operations of the flowchart 800 may start at 802.

At 802, the first information 204A including the location information associated with the set of solar panels 106 of the PV power plant 104 and the configuration information associated with the set of solar panels 106 of the PV power plant 104 may be obtained. In an embodiment, the processor 202 of the system 102 may be configured to obtain the first information 204A including the location information associated with the set of solar panels 106 of the PV power plant 104 and the configuration information associated with the set of solar panels 106 of the PV power plant 104. Details about the first information retrieval are provided in FIG. 2 and FIG. 3.

At 804, the second information 204B including the real-time operating parameters associated with the PV power plant 104 may be obtained. In an embodiment, the processor 202 of the system 102 may be obtained to obtain the second information 204B including the real-time operating parameters associated with the PV power plant 104 from the set of sensors 108 based on the obtained first information 204A. Each sensor of the set of sensors 108 may be associated with the set of solar panels 106. Details about the second information retrieval are provided in FIG. 2 and FIG. 3.

At 806, the obtained first information 204A and the obtained second information 204B may be provided to the machine learning model 112. In an embodiment, the processor 202 of the system 102 may be configured to provide the obtained first information 204A and obtained second information 204B to the machine learning model 112 as the input. The machine learning model 112 may be the pre-trained model. Details about the machine learning model application operation are provided in FIG. 2 and FIG. 3.

At 808, the soiling loss 204D associated with the set of solar panels 106 may be determined. In an embodiment, the processor 202 of the system 102 may be configured to determine the soiling loss 204D associated with the set of solar panels 106 based on the output of the machine learning model 112. Details about the soiling loss determination operation are provided in FIG. 2 and FIG. 3.

At 810, the one or more instructions associated with the cleaning of at least one solar panel of the set of solar panels 106 may be transmitted to the set of robots or the set of user devices based on determined soiling loss 204D. In an embodiment, the processor 202 of the system 102 may be configured to transmit the one or more instructions associated with cleaning of at least one solar panel of the set of solar panels 106 to the set of robots or the set of user devices based on the determined soiling loss 204D. The set of user devices may be associated with the set of operators associated with the PV power plant 104. Details about the transmission operation are provided in FIG. 3.

Accordingly, blocks of the flowchart 800 support combinations of means for performing the specified functions and combinations of operations for performing the specified functions. It will also be understood the one or more blocks of the flowchart 800 and can be implemented by special-purpose hardware-based computer systems which perform the specified functions, or combinations of special-purpose hardware and computer instructions.

Alternatively, the system 102 may include means for performing each of the operations described above. In this regard, according to an example embodiment, examples of means for performing operations may include, for example, the processor 202 and/or a device or circuit for executing the computer program instructions or executing an algorithm for processing information as described above.

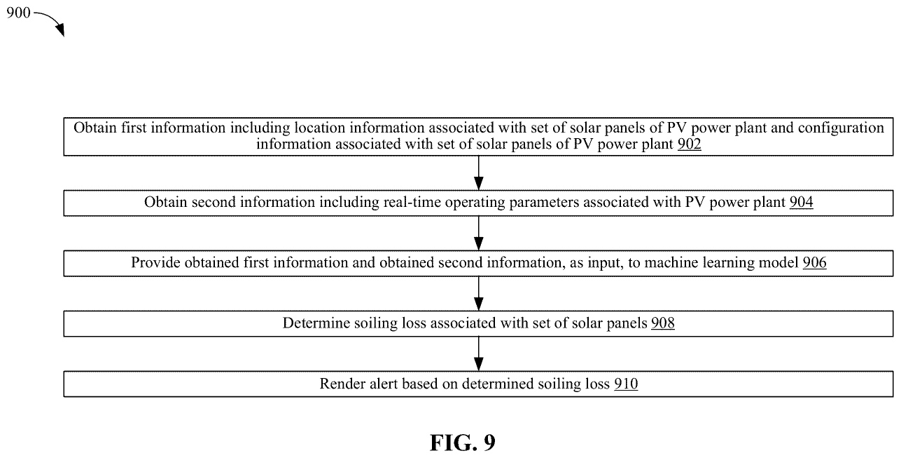

FIG. 9 is a flowchart 900 that illustrates a second exemplary method for determination of soiling loss on solar panels of the PV power plant 104, in accordance with an embodiment of the disclosure. FIG. 8 is explained in conjunction with FIG. 1, FIG. 2, FIG. 3, FIG. 4, FIG. 5, FIG. 6A, FIG. 6B, FIG. 6C, FIG. 7, and FIG. 8. With reference to FIG. 9, there is shown the flowchart 900. The operations of the exemplary method may be executed by the system 102 of FIG. 1 or the processor 202 of FIG. 2. The operations of the flowchart 900 may start at 902.

At 902, the first information 204A including the location information associated with the set of solar panels 106 of the PV power plant 104 and the configuration information associated with the set of solar panels 106 of the PV power plant 104 may be obtained. In an embodiment, the system 102 may be configured to obtain the first information 204A including the location information associated with the set of solar panels 106 of the PV power plant 104 and the configuration information associated with the set of solar panels 106 of the PV power plant 104. Details about the first information retrieval are provided in FIG. 2 and FIG. 3.

At 904, the second information 204B including the real-time operating parameters associated with PV power plant 104 may be obtained. In an embodiment, the system 102 may be obtained to obtain the second information 204B including the real-time operating parameters associated with the PV power plant 104 from the set of sensors 108 based on the obtained first information 204A. The set of sensors 108 may be associated with the set of solar panels 106. Details about the second information retrieval are provided in FIG. 2 and FIG. 3.

At 906, the obtained first information 204A and the obtained second information 204B may be provided to the machine learning model 112. In an embodiment, the system 102 may be configured to provide the obtained first information 204A and obtained second information 204B to the machine learning model 112 as the input. The machine learning model 112 may be the pre-trained model. Details about the machine learning model application operation are provided in FIG. 2 and FIG. 3.

At 908, the soiling loss 204D associated with the set of solar panels 106 may be determined. In an embodiment, the system 102 may be configured to determine the soiling loss 204D associated with the set of solar panels 106 based on the output of the machine learning model 112. Details about the soiling loss determination operation are provided in FIG. 2 and FIG. 3.

At 910, alert 504 may be rendered based on the determined soiling loss 204D. In an embodiment, the system 102 may be configured to render the alert 504 based on the determined soiling loss 204D. Details about the alert rendering operation are provided in FIG. 2 and FIG. 3.

Accordingly, blocks of the flowchart 900 support combinations of means for performing the specified functions and combinations of operations for performing the specified functions. It will also be understood the one or more blocks of the flowchart 900 and can be implemented by special-purpose hardware-based computer systems which perform the specified functions, or combinations of special-purpose hardware and computer instructions.

Alternatively, the system 102 may include means for performing each of the operations described above. In this regard, according to an example embodiment, examples of means for performing operations may include, for example, the processor 202 and/or a device or circuit for executing the computer program instructions or executing an algorithm for processing information as described above.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

What is claimed:

1. A system, comprising:
a memory to store computer-executable instructions; and
one or more processors coupled to the memory, wherein the one or more processors are configured to:
obtain first information comprising location information associated with a set of solar panels of a photovoltaic (PV) power plant and configuration information associated with the set of solar panels of the PV power plant;
obtain, from a set of sensors, second information comprising real-time operating parameters associated with the PV power plant based on the obtained first information, wherein each sensor of the set of sensors is associated with the set of solar panels;
provide, as an input, the obtained first information, and the obtained second information to a machine learning (ML) model, wherein the ML model is a pre-trained model;
determine a soiling loss associated with the set of solar panels based on an output of the ML model; and
render an alert based on determined soiling loss.

2. The system of claim 1, wherein the one or more processors are further configured to:
compare the determined soling loss with a pre-determined threshold loss; and
render the alert based on the comparison.

3. The system of claim 1, wherein the real-time operating parameters comprises of: an operational current parameter associated with the set of solar panels, an operational voltage parameter associated with the set of solar panels, a tilt angle of one or more trackers associated with the set of solar panels, and an internal temperature of an inverter associated with the PV power plant.

4. The system of claim 1, wherein the first information further comprises of real-time weather information associated a location of installation of the set of solar panels, and wherein the location information associated with the set of solar panels comprises of the location associated with the set of solar panels.

5. The system of claim 4, wherein the real-time weather information associated with the location of the set of solar panels comprises at least one of: solar irradiance at the location of the set of solar panels, a wind speed at the location of the set of solar panels, a wind direction at the location of the set of solar panels, an ambient temperature at the location of the set of solar panels, solar irradiance at a front plane of the set of solar panels, solar irradiance at a rear plane of the set of solar panels, a temperature of the set of solar panels, a rainfall measurement at the location of set of solar panels or a humidity at the location of the set of solar panels.

6. The system of claim 5, wherein the one or more processors are further configured to:
validate the obtained second information associated with the set of solar panels based on application of one or more data validation techniques on the obtained second information; and
provide, as the input, the validated second information and the real-time weather information to the ML model.

7. The system of claim 1, wherein the one or more processors are further configured to:
obtain, from one or more sources, reference information associated with the set of solar panels based on the obtained second information, wherein the reference information comprises at least one of: a commissioning date associated with the set of solar panels or a pre-determined threshold loss;
provide, as the input, the obtained reference information to the ML model; and
determine the soiling loss associated with the set of solar panels based on the output of the ML model.

8. The system of claim 1, wherein the output of the ML model is a diagnostic chart indicative of one of: an increase in the soiling loss over a first time period, or a decrease in the soiling loss over the first time period.

9. The system of claim 8, wherein the obtained second information associated with the set of solar panels is constrained with respect to the first time period.

10. A method, comprising:
obtaining first information comprising location information associated with a set of solar panels of a photovoltaic (PV) power plant and configuration information associated with the set of solar panels of the PV power plant;
obtaining, from a set of sensors, second information comprising real-time operating parameters associated with the PV power plant based on the obtained first information, wherein each sensor of the set of sensors is associated with the set of solar panels;
providing, as an input, the obtained first information, and the obtained second information to a machine learning (ML) model, wherein the ML model is a pre-trained model;
determining a soiling loss associated with the set of solar panels based on an output of the ML model; and
rendering an alert based on determined soiling loss.

11. The method of claim 10, wherein the method further comprising:
comparing the determined soling loss with a pre-determined threshold loss; and
rendering the alert based on the comparison.

12. The method of claim 10, wherein the real-time operating parameters comprises of: an operational current parameter associated with the set of solar panels, an operational voltage parameter associated with the set of solar panels, a tilt angle of one or more trackers associated with the set of solar panels, and an internal temperature of an inverter associated with the PV power plant.

13. The method of claim 10, wherein the first information further comprises of real-time weather information associated a location of installation of the set of solar panels, and wherein the location information associated with the set of solar panels comprises of the location associated with the set of solar panels.

14. The method of claim 13, wherein the real-time weather information associated with the location of the set of solar panels comprises at least one of: solar irradiance at the location of the set of solar panels, a wind speed at the location of the set of solar panels, a wind direction at the location of the set of solar panels, an ambient temperature at the location of the set of solar panels, solar irradiance at a front plane of the set of solar panels, solar irradiance at a rear plane of the set of solar panels, a temperature of the set of solar panels, a rainfall measurement at location of set of solar panels or a humidity at the location of the set of solar panels.

15. The method of claim 14, wherein the method further comprising:
validating the obtained second information associated with the set of solar panels based on application of one or more data validation techniques on the obtained second information; and
providing, as the input, the validated second information and the real-time weather information to the ML model.

16. The method of claim 10, wherein the method further comprising:
obtaining, from one or more sources, reference information associated with the set of solar panels based on the obtained second information, wherein the reference information comprises at least one of: a commissioning date associated with the set of solar panels or a pre-determined threshold loss;
providing, as the input, the obtained reference information to the ML model; and
determining the soiling loss associated with the set of solar panels based on the output of the ML model.

17. The method of claim 10, wherein the output of the ML model is a diagnostic chart indicative of one of: an increase in the soiling loss over a first time period, or a decrease in the soiling loss over the first time period, and wherein the obtained second information associated with the set of solar panels is constrained with respect to the first time period.

18. The method of claim 17, wherein the diagnostic chart corresponds to a heatmap associated with the PV power plant, and wherein the heatmap indicates a distribution of the soiling loss over the PV power plant.

19. The method of claim 10, wherein the method further comprising:
generating one or more charts indicative of the soiling loss based on the obtained first information, obtained second information, the determined soiling loss, and a training dataset associated with historical soiling loss events, wherein the ML model is pre-trained on the training dataset; and
rendering the generated one or more charts.

20. A computer programmable product comprising a non-transitory computer readable medium having stored thereon computer executable instructions, which when executed by one or more processors, cause the one or more processors to conduct operations, comprising:
obtaining first information comprising location information associated with a set of solar panels of a photovoltaic (PV) power plant and configuration information associated with the set of solar panels of the PV power plant;
obtaining, from a set of sensors, second information comprising real-time operating parameters associated with the PV power plant based on the obtained first information, wherein each sensor of the set of sensor is associated with the set of solar panels;
providing, as an input, the obtained first information, and the obtained second information to a machine learning (ML) model, wherein the ML model is a pre-trained model;
determining a soiling loss associated with the set of solar panels based on an output of the ML model; and
transmitting, to at least one of: a set of robots or a set of user devices, one or more instructions associated with cleaning of at least one solar panel of the set of solar panels based on the determined soiling loss, wherein the set of user devices are associated with a set of operators associated with the PV power plant.
